(19) United States
(12) Patent Application Publication
(10) Pub. No.: US 2026/0038198 A1
(43) Pub. Date: Feb. 5, 2026

(54) GLASS MEASUREMENT AND CABLE LAYOUT FOR WINDOWS OF AN ENCLOSURE

(71) Applicant: View Operating Corporation, San Jose, CA (US)

(72) Inventors: Sridharan GANDHI, San Jose, CA (US); Disha BHAIYA, San Jose, CA (US); Shalini GALI, Mysuru (IN); Henry John KELLNER, Nokomis, FL (US); Sridhar Karthik KAILASAM, Fremont, CA (US); Deepak SHIVAPRASAD, Dublin, CA (US); Illayathambi KUNADIAN, San Jose, CA (US); Ranojoy DUTTA, Allen, TX (US); Yafim SIMANOVSKY, Telaviv, IL (US); Christopher Lance DONG, San Leandro, CA (US)

(73) Assignee: View Operating Corporation, San Jose, CA (US)

(21) Appl. No.: 19/244,993

(22) Filed: Jun. 20, 2025

Related U.S. Application Data
(63) Continuation of application No. PCT/US2023/084673, filed on Dec. 18, 2023.
(60) Provisional application No. 63/476,437, filed on Dec. 21, 2022.

(51) Int. Cl. G06T 17/00; G06T 7/73

(52) U.S. Cl. CPC G06T 17/00; G06T 7/73; G06T 2200/24; G06T 2207/20092; G06T 2207/30184; G06T 2210/04

(57) ABSTRACT

In some implementations, a computer system may obtain a virtual three-dimensional (3D) model of the enclosure, the virtual 3D model having a plurality of windows. The computer system may categorize the plurality of windows of the virtual 3D model into a plurality of window types based at least in part on one or more features of the plurality of windows. The computer system may determine a frame bite for one or more windows in a set of window types comprising one or more of the plurality of window types. The computer system may determine a total amount of glass for the windows in the set of window categories, wherein the determined total amount of glass accounts for the determined frame bite for the one or more windows in the set of window groups. The computer system may provide, with the computer system, output data indicative of the determined total amount of glass for the windows in the set of window types.

### PRIORITY APPLICATIONS

This application is a continuation of International Application No. PCT/US2023/084673, filed on Dec. 18, 2023, which claims the benefit of U.S. Provisional Patent Application Ser. No. 63/476,437, filed Dec. 21, 2022, titled “GLASS MEASUREMENT AND CABLE LAYOUT FOR WINDOWS OF AN ENCLOSURE.” Each of the patent documents recited above is incorporated herein by reference in its entirety.

### BACKGROUND

Some optically-switchable windows comprising electrochromic materials can be electronically controlled to, for example, adjust the amount of light and heat that passes through them. Such windows often can be found on the exterior of enclosures, such as buildings or other types of facilities. For an enclosure that is being designed, proper accounting for windows, including such optically-switchable windows, may often overlook certain aspects, such as frame bite. This can lead to an incorrect accounting for a bill of materials (BOM) for the enclosure. Further, routing cables to the windows to power and/or control the optically-switching functionality can be a challenging aspect of the design of an enclosure.

### SUMMARY

An example method performed by a computer system for accurate glass measurement of an enclosure, according to this disclosure, may comprise obtaining a virtual three-dimensional (3D) model of the enclosure, the virtual 3D model having a plurality of windows. The method also may comprise categorizing the plurality of windows of the virtual 3D model into a plurality of window types based at least in part on one or more features of the plurality of windows. The method also may comprise determining a frame bite for one or more windows in a set of window types comprising one or more of the plurality of window types. The method also may comprise determining a total amount of glass for the windows in the set of window categories, wherein the determined total amount of glass accounts for the determined frame bite for the one or more windows in the set of window groups. The method also may comprise providing, with the computer system, output data indicative of the determined total amount of glass for the windows in the set of window types.

An example computer system, according to this disclosure, comprises: at least one memory and at least one processor communicatively coupled with the at least one memory. The at least one processor may be configured to obtain a virtual three-dimensional (3D) model of an enclosure, the virtual 3D model having a plurality of windows. The at least one processor further may be configured to categorize the plurality of windows of the virtual 3D model into a plurality of window types based at least in part on one or more features of the plurality of windows. The at least one processor further may be configured to determine a frame bite for one or more windows in a set of window types comprising one or more of the plurality of window types. The at least one processor further may be configured to determine a total amount of glass for the windows in the set of window categories, wherein the determined total amount of glass accounts for the determined frame bite for the one or more windows in the set of window groups. The at least one processor further may be configured to provide, with the computer system, output data indicative of the determined total amount of glass for the windows in the set of window types.

According to this disclosure, an example non-transitory computer-readable medium stores instructions for accurate glass measurement of an enclosure, the instructions comprising code for obtaining a virtual three-dimensional (3D) model of the enclosure, the virtual 3D model having a plurality of windows. The instructions further may comprise code for categorizing the plurality of windows of the virtual 3D model into a plurality of window types based at least in part on one or more features of the plurality of windows. The instructions further may comprise code for determining a frame bite for one or more windows in a set of window types comprising one or more of the plurality of window types. The instructions further may comprise code for determining a total amount of glass for the windows in the set of window categories, wherein the determined total amount of glass accounts for the determined frame bite for the one or more windows in the set of window groups. The instructions further may comprise code for providing, with the computer system, output data indicative of the determined total amount of glass for the windows in the set of window types.

The content of this summary section is provided as a simplified introduction to the disclosure and is not intended to be used to limit the scope of any invention disclosed herein or the scope of the appended claims.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

These and other features and embodiments will be described in more detail with reference to the drawings.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings or figures (also “FIG.” and “Figs.” herein), of which:

FIG. 1 is a simplified diagram showing cross-section depicting formation of an electrochromic device stack;

FIG. 2 is a diagram of control system for a building;

FIG. 3 is a block diagram of a control system;

FIG. 4 is a diagram of a hierarchal structure in which devices may be arranged;

FIG. 5 is a flow diagram of a process for obtaining a bill of materials (BOM), according to an embodiment;

FIG. 6 is a flow diagram of a method for modeling, according to an embodiment;

FIG. 7 is a simplified profile view of an example visualization of the virtual model of a building;

FIG. 8 is profile view of another example visualization of the virtual model of a building;

FIG. 9 is a flow diagram of a method of performing takeoff, according to an embodiment;

FIG. 10 is an illustration of a graphical interface that can be provided to a user for identifying window groups in a visualization of the virtual model of a building, according to an embodiment;

FIG. 11A is an illustration of a table that can be provided in a graphical user interface to enable frame bite identification, according to an embodiment;

FIG. 11B an illustration of a visualization of a virtual model of a building (showing a portion of the outside of the building with several windows);

FIG. 12 is a visualization of a virtual model of the building that may be provided in conjunction with the takeoff process, according to an embodiment;

FIG. 13 is a flow diagram of an embodiment of a method for cable layout;

FIG. 14 is a diagram of a portion of an example floor plan that may be used a window clustering algorithm, according to an embodiment;

FIG. 15 is another diagram of a portion of an example floor plan that may be used a window clustering algorithm, according to an embodiment;

FIG. 16 is another diagram of a portion of an example floor plan that may be used a window clustering algorithm, according to an embodiment;

FIG. 17 is a flow diagram of a method performed by a computer system for accurate glass measurement of an enclosure, according to an embodiment;

FIG. 18 is a flow diagram of a method performed by a computer system for performing cable layout for powering and/or providing data to a plurality of windows of an enclosure, according to an embodiment; and

FIG. 19 schematically depicts an embodiment of a computer system.

The figures and components therein may not be drawn to scale. Various components of the figures described herein may not be drawn to scale.

### DETAILED DESCRIPTION

While various embodiments of the invention are shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein might be employed.

As noted, the design process of a building or other enclosure may involve an accounting of at least a portion of windows (e.g., optically-switchable windows) of the building in order to, for example, provide an accurate bill of materials (BOM) and/or bill of quantities. This accounting, known as “takeoff,” may comprise a determination from building plans or drawings of the total amount (e.g., volume) of glass, number of windows, type of windows, or a combination thereof. Takeoff may be performed using a virtual model of a building, such as multidimensional (e.g. two-dimensional (2D) or three-dimensional (3D)) architectural plans. (As described herein, a “virtual model of a building” may also be referred to as a “virtual building model.”) A virtual model of a building may be represented in a computer-aided design (CAD) file, such as a building information modeling (BIM) file. Using a CAD software such as Trimble Navigation's SketchUp™, Autodesk Revit, or the like, a user (e.g., architect, engineer, contractor, building material supplier, etc.) may create, view, or manipulate the virtual model of the building, or perform any combination thereof.

Traditionally, performing takeoff using a virtual model of a building can take weeks, depending on the complexity of the building. Using CAD software, a user may need to manually identify all relevant external windows for takeoff, categorize and sort them. Further, manual processes may often fail to account for frame bite, which is a portion of a window where glass and support structure (e.g., a mullion) overlap (i.e., there is a spatial offset between a window at the support structure). This failure can lead to an underestimate in the size and overall amount of glass needed for windows, leading to an underestimate in the amount of glass for the building as a whole.

Embodiments can address these and other issues by implementing various operations that can be applied to a virtual model of a building to streamline the takeoff process. As described in more detail hereafter, operations can include operations that identify and categorize windows of a virtual model of a building into different window types, determine frame bite and a total amount of glass for windows for one or more window types, and output data indicative of the determined total amount of glass. These operations may be implemented, for example, using a stand-alone software program to access the model (e.g., BIM file) and/or using a plug-in, script, extension, or combination thereof, executable within an existing CAD software program.

Additionally or alternatively, embodiments can facilitate the routing of cables to windows. As described in further detail herein, certain types of windows, such as optically-switching windows, may use power to perform functions such as increasing or decreasing window tint, altering window hue, etc. According to some embodiments, various operations may be performed on a virtual model of a building to streamline such power cable routing by grouping windows into window clusters (using constraints regarding cable power capacity and window power usage), routing cables to each window cluster, in providing output data indicative of the number and length of cables.

Additional details regarding embodiments that enable such streamlining of takeoff and/or cable routing are provided hereafter, after the description of relevant terms and technology.

Terms such as “a,” “an,” and “the” are not intended to refer to only a singular entity but include the general class of which a specific example may be used for illustration. The terminology herein is used to describe specific embodiments of the invention(s), but their usage does not delimit the invention(s).

When ranges are mentioned, the ranges are meant to be inclusive, unless otherwise specified. For example, a range between value 1 and value 2 is meant to be inclusive and include value 1 and value 2. The inclusive range will span any value from about value 1 to about value 2. The term “adjacent” or “adjacent to,” as used herein, includes “next to,” “adjoining,” “in contact with,” and “in proximity to.”

As used herein, including in the claims, the conjunction “and/or” in a phrase such as “including X, Y, and/or Z”, refers to in inclusion of any combination or plurality of X, Y, and Z. For example, such phrase is meant to include X. For example, such phrase is meant to include Y. For example, such phrase is meant to include Z. For example, such phrase is meant to include X and Y. For example, such phrase is meant to include X and Z. For example, such phrase is meant to include Y and Z. For example, such phrase is meant to include a plurality of Xs. For example, such phrase is meant to include a plurality of Ys. For example, such phrase is meant to include a plurality of Zs. For example, such phrase is meant to include a plurality of Xs and a plurality of Ys. For example, such phrase is meant to include a plurality of Xs and a plurality of Zs. For example, such phrase is meant to include a plurality of Ys and a plurality of Zs. For example, such phrase is meant to include a plurality of Xs and Y. For example, such phrase is meant to include a plurality of Xs and Z. For example, such phrase is meant to include a plurality of Ys and Z. For example, such phrase is meant to include X and a plurality of Ys. For example, such phrase is meant to include X and a plurality of Zs. For example, such phrase is meant to include Y and a plurality of Zs. The conjunction “and/or” is meant to have the same effect as the phrase “X, Y, Z, or any combination or plurality thereof.” The conjunction “and/or” is meant to have the same effect as the phrase “one or more X, Y, Z, or any combination thereof.”

The term “operatively coupled” or “operatively connected” refers to a first element (e.g., mechanism) that is coupled (e.g., connected) to a second element, to allow the intended operation of the second and/or first element. The coupling may comprise physical or non-physical coupling (e.g., communicative coupling). The non-physical coupling may comprise signal-induced coupling (e.g., wireless coupling). Coupled can include physical coupling (e.g., physically connected), or non-physical coupling (e.g., via wireless communication). Operatively coupled may comprise communicatively coupled.

An element (e.g., mechanism) that is “configured to” perform a function includes a structural feature that causes the element to perform this function. A structural feature may include an electrical feature, such as a circuitry or a circuit element. A structural feature may include an actuator. A structural feature may include a circuitry (e.g., comprising electrical or optical circuitry). Electrical circuitry may comprise one or more wires. Optical circuitry may comprise at least one optical element (e.g., beam splitter, mirror, lens and/or optical fiber). A structural feature may include a mechanical feature. A mechanical feature may comprise a latch, a spring, a closure, a hinge, a chassis, a support, a fastener, or a cantilever, and so forth. Performing the function may comprise utilizing a logical feature. A logical feature may include programming instructions. Programming instructions may be executable by at least one processor. Programming instructions may be stored or encoded on a medium accessible by one or more processors. Additionally, in the following description, the phrases “operable to,” “adapted to,” “configured to,” “designed to,” “programmed to,” or “capable of” may be used interchangeably where appropriate.

Further, as used herein, the terms pane, and lite are used interchangeably. A window, including an electrochromic window, may be in the form of an insulated glass unit (IGU), a laminate structure or both, e.g., where an IGU has one or more laminated panes as its lites, e.g., a double pane IGU where one pane is a single sheet of glass and the other pane is a laminate of two sheets of glass. A laminate may include two, three or more sheets of glass.

As noted, the multi-dimensional model of an enclosure (e.g., 2D or 3D model of a building) is produced by a computer-aided design software which has a modeling environment for the design and examination of building structures. In some cases, pairing the network ID of each of the optically switchable (e.g., tintable) windows with at least one network node ID includes storing each pairing in a network configuration file. A node can be a device that is operatively (e.g., communicatively) coupled to the network.

In some embodiments, an enclosure comprises an area defined by at least one structure. The at least one structure may comprise at least one wall. An enclosure may comprise and/or enclose one or more sub-enclosure. The at least one wall may comprise metal (e.g., steel), clay, stone, plastic, glass, plaster (e.g., gypsum), polymer (e.g., polyurethane, styrene, or vinyl), asbestos, fiber-glass, concrete (e.g., reinforced concrete), wood, paper, or a ceramic. The at least one wall may comprise wire, bricks, blocks (e.g., cinder blocks), tile, drywall, or frame (e.g., steel frame).

In some embodiments, the enclosure comprises one or more openings. The one or more openings may be reversibly closable. The one or more openings may be permanently open. A fundamental length scale of the one or more openings may be smaller relative to the fundamental length scale of the wall(s) that define the enclosure. A fundamental length scale may comprise a diameter of a bounding circle, a length, a width, or a height. A surface of the one or more openings may be smaller relative to the surface the wall(s) that define the enclosure. The opening surface may be a percentage of the total surface of the wall(s). For example, the opening surface can measure at most about 30%, 20%, 10%, 5%, or 1% of the walls(s). The wall(s) may comprise a floor, a ceiling, or a side wall. The closable opening may be closed by at least one window or door. The enclosure may be at least a portion of a facility. The facility may comprise a building. The enclosure may comprise at least a portion of a building. The building may be a private building and/or a commercial building. The building may comprise one or more floors. The building (e.g., floor thereof) may include at least one of: a room, hall, foyer, attic, basement, balcony (e.g., inner or outer balcony), stairwell, corridor, elevator shaft, façade, mezzanine, penthouse, garage, porch (e.g., enclosed porch), terrace (e.g., enclosed terrace), cafeteria, and/or duct. In some embodiments, an enclosure may be stationary and/or movable (e.g., a train, an airplane, a ship, a vehicle, or a rocket).

In some embodiments, a one or more target devices may be operatively (e.g., communicatively) coupled to a control system that may be used to among other things, control the tinting and/or other functionality of windows. The plurality of devices may be disposed in a facility (e.g., including a building and/or room). The control system may comprise the hierarchy of controllers. The target devices may comprise an emitter, a sensor, or a (e.g., tintable) window (e.g., IGU). The device may be any device as disclosed herein. At least two of the plurality of devices may be of the same type. For example, two or more IGUs may be coupled to the control system. At least two of the plurality of devices may be of different types. For example, a sensor and an emitter may be coupled to the control system. At times, the plurality of devices may comprise at least 20, 50, 100, 500, 1000, 2500, 5000, 7500, 10000, 50000, 100000, or 500000 devices. The plurality of devices may be of any number between the aforementioned numbers (e.g., from 20 devices to 500000 devices, from 20 devices to 50 devices, from 50 devices to 500 devices, from 500 devices to 2500 devices, from 1000 devices to 5000 devices, from 5000 devices to 10000 devices, from 10000 devices to 100000 devices, or from 100000 devices to 500000 devices). For example, the number of windows in a floor may be at least 5, 10, 15, 20, 25, 30, 40, or 50. The number of windows in a floor can be any number between the aforementioned numbers (e.g., from 5 to 50, from 5 to 25, or from 25 to 50). At times, the devices may be in a multi-story building. At least a portion of the floors of the multi-story building may have devices controlled by the control system (e.g., at least a portion of the floors of the multi-story building may be controlled by the control system). For example, the multi-story building may have at least 2, 8, 10, 25, 50, 80, 100, 120, 140, or 160 floors that are controlled by the control system. The number of floors (e.g., devices therein) controlled by the control system may be any number between the aforementioned numbers (e.g., from 2 to 50, from 25 to 100, or from 80 to 160). The floor may be of an area of at least about 150 m², 250 m², 500 m², 1000 m², 1500 m², or 2000 square meters (m²). The floor may have an area between any of the aforementioned floor area values (e.g., from about 150 m² to about 2000 m², from about 150 m² to about 500 m^{2,} from about 250 m² to about 1000 m², or from about 1000 m² to about 2000 m²).

In various embodiments, a network infrastructure supports a control system for one or more windows such as tintable (e.g., electrochromic) windows. The control system may comprise one or more controllers operatively coupled (e.g., directly or indirectly) to one or more windows. While the disclosed embodiments describe optically switchable windows (also referred to as “smart windows”) such as tintable or electrochromic windows, the concepts disclosed herein may apply to other types of switchable optical devices comprising a liquid crystal device, an electrochromic device, suspended particle device (SPD), NanoChromics display (NCD), Organic electroluminescent display (OELD), suspended particle device (SPD), NanoChromics display (NCD), or an Organic electroluminescent display (OELD). The display element may be attached to a part of a transparent body (such as the windows). The optically-switchable window may be disposed in a (non-transitory) facility such as a building, and/or in a transitory facility (e.g., vehicle) such as a car, RV, bus, train, airplane, helicopter, ship, or boat.

In some embodiments, an optically-switchable window, which may comprise a tintable window, exhibits a (e.g., controllable and/or reversible) change in at least one optical property of the window, e.g., when a stimulus is applied. The change may be a continuous change. A change may be to discrete tint levels (e.g., to at least about 2, 4, 8, 16, or 32 tint levels). The optical property may comprise hue, or transmissivity. The hue may comprise color. The transmissivity may be of one or more wavelengths. The wavelengths may comprise ultraviolet, visible, or infrared wavelengths. The stimulus can include an optical, electrical and/or magnetic stimulus. For example, the stimulus can include an applied voltage and/or current. One or more optically-switchable windows can be used to control lighting and/or glare conditions, e.g., by regulating the transmission of solar energy propagating through them. One or more optically-switchable windows can be used to control a temperature within a building, e.g., by regulating the transmission of solar energy propagating through the window. Control of the solar energy may control heat load imposed on the interior of the facility (e.g., building). The control may be manual and/or automatic. The control may be used for maintaining one or more requested (e.g., environmental) conditions, e.g., occupant comfort. The control may include reducing energy consumption of a heating, ventilation, air conditioning and/or lighting systems. At least two of heating, ventilation, and air conditioning may be induced by separate systems. At least two of heating, ventilation, and air conditioning may be induced by one system. The heating, ventilation, and air conditioning may be induced by a single system (abbreviated herein as “HVAC”). In some cases, optically-switchable windows may be responsive to (e.g., and communicatively coupled to) one or more environmental sensors and/or user control. optically-switchable windows may comprise (e.g., may be) electrochromic windows. The windows may be located in the range from the interior to the exterior of a structure (e.g., facility, e.g., building). However, this need not be the case. optically-switchable windows may operate using liquid crystal devices, suspended particle devices, microelectromechanical systems (MEMS) devices (such as microshutters), or any technology known now, or later developed, that is configured to control light transmission through a window. Windows (e.g., with MEMS devices for tinting) are described in U.S. Pat. No. 10,359,681, issued Jul. 23, 2019, filed May 15, 2015, titled “MULTI-PANE WINDOWS INCLUDING ELECTROCHROMIC DEVICES AND ELECTROMECHANICAL SYSTEMS DEVICES,” and incorporated herein by reference in its entirety. In some cases, one or more optically-switchable windows can be located within the interior of a building, e.g., between a conference room and a hallway. In some cases, one or more optically-switchable windows can be used in automobiles, trains, aircraft, and other vehicles, e.g., in lieu of a passive and/or non-tinting window.

Optically-switchable windows may comprise electrochromic windows, which may be used in a variety of settings, for example in office buildings and residential buildings. The complexity of many conventional electrochromic windows (e.g., wiring, installation, and programming of a controller, etc.) may discourage their use. For example, residential customers are likely to have windows installed by local contractors who may be unfamiliar with electrochromic windows and their installation requirements. As such, one goal in certain disclosed embodiments is to provide electrochromic IGUs and window assemblies that are as easy to install as non-electrochromic windows. Certain disclosed features that promote easy installation include wireless power capability and/or self-power capability, wireless control communication, self-meshing networks, on-board controllers, automated commissioning, and a form factor matching commonly available windows, e.g., double-pane or triple-pane IGUs. Easy installation may refer to installation that is quick, requires labor with minimal qualifications, robust (e.g., not prone to errors), and cheap. Other target devices that may be included in various embodiments include, cellular or other antenna (e.g., provided on a window), a cellular repeater (e.g., in a controller), touch panel controls (e.g., attached to a media display construct), mountable and/or removable controllers, learning functionality, weather tracking, sharing of sensor outputs and other control information (e.g., between devices coupled to the network such as windows), sub-frames that may include certain controller components, wireless bus bars, optical (e.g., built-in photo) sensors, other sensors, etc. Any two or more of these target devices may be combined as requested for a particular application.

Some embodiments of electrochromic windows and/or other electrochromic devices may comprise first and second electrochromic layers that include a cathodically tinting layer and an anodically tinting layer. In such embodiments, the first and second electrochromic layers will tint when exposed to opposite polarities. For example, the first electrochromic layer may tint under an applied cathodic potential (and clear under an applied anodic potential), while the second electrochromic layer may tint under an applied anodic potential (and clear under an applied cathodic potential). Of course, the arrangement can be reversed for some applications. Either way, the first and second electrochromic layers may work in concert to tint and clear.

In some embodiments, one of the first and second electrochromic layers can be substituted with a non-electrochromic ion storage layer. In such cases, (e.g., only) one of the two layers exhibits electrochromism such that it tints and clears under application of suitable potentials. The other layer, sometimes referred to as a counter electrode layer, simply serves as an ion reservoir when the other layer is exposed to a cathodic potential.

In some embodiments, a device stack has distinct layers, while in other embodiments, electrochromic stacks may be graded structures or may include additional components such as an antenna structure. While some of the discussion in the present disclosure focuses on windows having electrochromic devices, the disclosure may more generally pertains to windows having any type of optically switchable device such as liquid crystal devices and suspended particle devices, as well as to target devices other than optically-switchable windows including any electrically controllable devices such as a sensor, an emitter, an ensemble of sensors and/or emitters, a media display construct, an antenna, a router, a transceiver, a controller (e.g., microcontroller), a processor, a table, a chair, a door, a lighting device, a heater, a ventilator, an air-conditioning device, an alarm, or any other identifiable device associated with the facility.

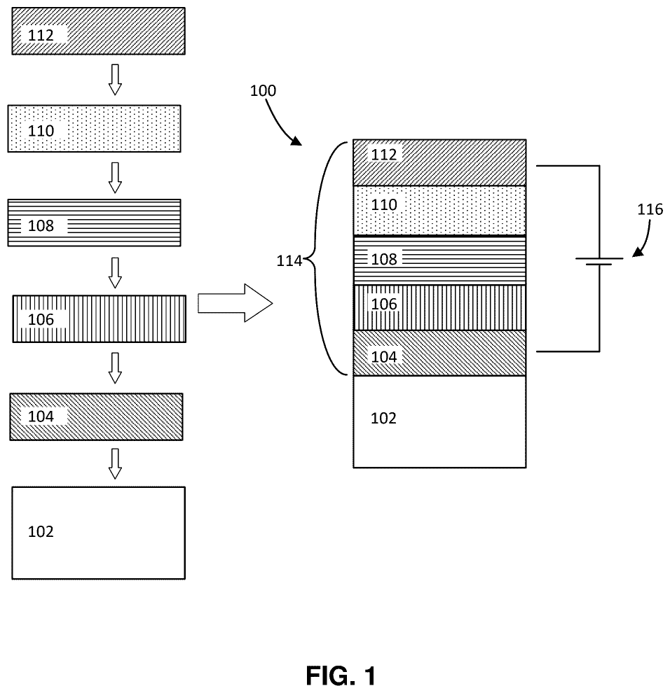

FIG. 1 depicts an electrochromic device 100 disposed on a substrate 102. Device 100 includes, in the following order starting from the substrate 102, a first conductive layer 104, a first electrochromic layer (EC1) 106, an ion conductor layer (IC) 108, a second electrochromic layer (EC2) 110, and a second conductive layer 112. Components 104, 106, 108, 110, and 112 are collectively referred to as an electrochromic stack 114. In some embodiments, the transparent conductor layers are made of a transparent material such as a transparent conductive oxide, which may be referred to as a “TCO.” Since the TCO layers are transparent, the tinting behavior of the EC1-IC-EC2 stack may be observable through the TCO layers, for example, allowing use of such devices on a window for reversible shading. A voltage source 116, operable to apply an electric potential across electrochromic stack 114, effects the transition of the electrochromic device from, for example, a clear state (i.e., transparent) to a tinted state. In some embodiments, the electrochromic device may not include a distinct ion conductor layer. See U.S. Pat. No. 8,764,950 issued Jul. 1, 2014, and PCT Publication No. WO2015/168626, field May 1, 2015, both of which are incorporated herein by reference in their entireties.

In some embodiments, an IGU includes two (or more) substantially transparent substrates, for example, two panes of glass, where at least one substrate includes an electrochromic device disposed thereon, and the panes have a separator disposed between them. An IGU may be hermetically (e.g., gas) scaled, having an interior region that is isolated from the ambient environment. A “window assembly” may include an IGU or for example a stand-alone laminate, and includes electrical leads for connecting the IGUs or laminates of the one or more electrochromic devices to a voltage source, switches, and the like, and may include a frame that supports the IGU or laminate. A window assembly may include, or be operatively (e.g., communicatively) coupled to, a window controller (e.g., as described herein), and/or components of a window controller (e.g., a dock).

Window controllers may have many sizes, formats, and locations with respect to the optically switchable window(s) they control. The controller may be attached to glass of an IGU and/or laminate. The controller may be disposed in a frame that houses the IGU and/or laminate. A tintable (e.g., electrochromic) window may include one, two, three or more individual electrochromic panes (an electrochromic device on a transparent substrate). An individual pane of an electrochromic window may have an electrochromic coating that has independently tintable zones. A controller as described herein may control all electrochromic coatings associated with such windows, whether the electrochromic coating is monolithic or zoned.

The controller may be generally disposed in close proximity to the optically-switchable (e.g., electrochromic) window, generally adjacent to, on the glass, or inside an IGU, (e.g., within a frame of the self-contained assembly). In some embodiments, the window controller is an “in situ” controller; that is, the controller is part of a window assembly, an IGU and/or a laminate. The controller may not have to be matched with the optically-switchable window, and installed, in the field, e.g., the controller travels with the window as part of the assembly from the factory. The controller may be installed in the window frame of a window assembly or be part of an IGU and/or laminate assembly. The controller may be mounted on or between panes of the IGU or on a pane of a laminate. In cases where a controller is located on the visible portion of an IGU, at least a portion of the controller may be (e.g., substantially) transparent. Further examples of on-glass controllers are provided in U.S. patent application Ser. No. 14/951,410, filed Nov. 24, 2015, titled “SELF CONTAINED EC IGU,” which is herein incorporated by reference in its entirety. In some embodiments, a localized controller is provided as more than one part, with at least one part (e.g., including a memory component storing information about the associated optically-switchable window) being provided as a part of the window assembly and at least one other part being separate and configured to mate with the at least one part that is part of the window assembly, IGU or laminate. In some embodiments, a controller is an assembly of interconnected parts that are not in a single housing, but rather spaced apart, e.g., in the secondary seal of an IGU. In some embodiments the controller is a compact unit, e.g., in a single housing or in two or more components that combine, e.g., a dock and housing assembly, that is proximate the glass, not in the viewable area, or mounted on the glass in the viewable arca.

In one embodiment, the controller is incorporated into or onto the IGU and/or the window frame prior to installation of the optically-switchable window. In one embodiment, the controller is incorporated into or onto the IGU and/or the window frame prior to leaving the manufacturing facility. In one embodiment, the controller is incorporated into the IGU, substantially within the secondary seal. In another embodiment, the controller is incorporated into or onto the IGU, partially, substantially, or wholly within a perimeter defined by the primary seal between the scaling separator and the substrate.

Having the controller as part of an IGU and/or a window assembly, the IGU can possess logic and/or features of the controller that, e.g., travels with the IGU or window unit. For example, when a controller is part of an IGU assembly having an electrochromic window, in the event the characteristics of the electrochromic device(s) change over time (e.g., through degradation), a characterization function may be used, for example, to update control parameters used to drive tint state transitions. In another embodiment, if already installed in a optically-switchable window unit, the logic and/or features of the controller may be used to calibrate one or more of the control parameters, e.g., to match the intended installation. If already installed, the one or more control parameters may be recalibrated to match the performance characteristics of the optically-switchable window(s).

In some embodiments, a controller is not pre-associated with a window, but rather a dock component, e.g., having parts generic to any optically-switchable window, is associated with each window at the factory. After window installation, or otherwise in the field, a second component of the controller may be combined with the dock component to complete the optically-switchable window controller assembly. The dock component may include a chip which is programmed at the factory with the physical characteristics and/or parameters of the particular window to which the dock is attached (e.g., on the surface which will face the building's interior after installation, sometimes referred to as surface 4 or “S4”). The second component (sometimes called a “carrier,” “casing,” “housing,” or “controller”) may be mated with the dock, and when powered, the second component can read the chip and configure itself to power the window according to the particular characteristics and parameters stored on the chip. In this way, the shipped window need (e.g., only) have its associated parameters stored on a chip, which is integral with the window, while the more sophisticated circuitry and components can be combined later (e.g., shipped separately and installed by the window manufacturer after the glazier has installed the windows, followed by commissioning by the window manufacturer). In some embodiments, the chip is included in a wire or wire connector attached to the window controller. Such wires with connectors are sometimes referred to as pigtails.

As used herein, the term “outboard” means closer to the outside environment, while the term “inboard” means closer to the interior of a building. For example, in the case of an IGU having two panes, the pane located closer to the outside environment is referred to as the outboard pane or outer pane, while the pane located closer to the inside of the building is referred to as the inboard pane or inner pane. The different surfaces of the IGU may be referred to as S1, S2, S3, and S4 (assuming a two-pane IGU). S1 refers to the exterior-facing surface of the outboard lite (i.e., the surface that can be physically touched by someone standing outside). S2 refers to the interior-facing surface of the outboard lite. S3 refers to the exterior-facing surface of the inboard lite. S4 refers to the interior-facing surface of the inboard lite (i.e., the surface that can be physically touched by someone standing inside the building). In other words, the surfaces are labeled S1-S4 (not shown in FIG. 1), starting from the outermost surface of the IGU and counting inwards. In cases where an IGU includes three panes, this same trend holds (with S6 being the surface that can be physically touched by someone standing inside the building). In some embodiments employing two panes, the electrochromic device (or other optically switchable device) is disposed on S3.

Examples of optically-switchable (e.g., tintable) windows, window controllers, their methods of use and their features are presented in U.S. patent application Ser. No. 15/334,832, filed Oct. 26, 2016, titled “CONTROLLERS FOR OPTICALLY-SWITCHABLE DEVICES,” and U.S. patent application Ser. No. 16/082,793, filed Sep. 6, 2018, titled “METHOD OF COMMISSIONING ELECTROCHROMIC WINDOWS,” each of which is herein incorporated by reference in its entirety.

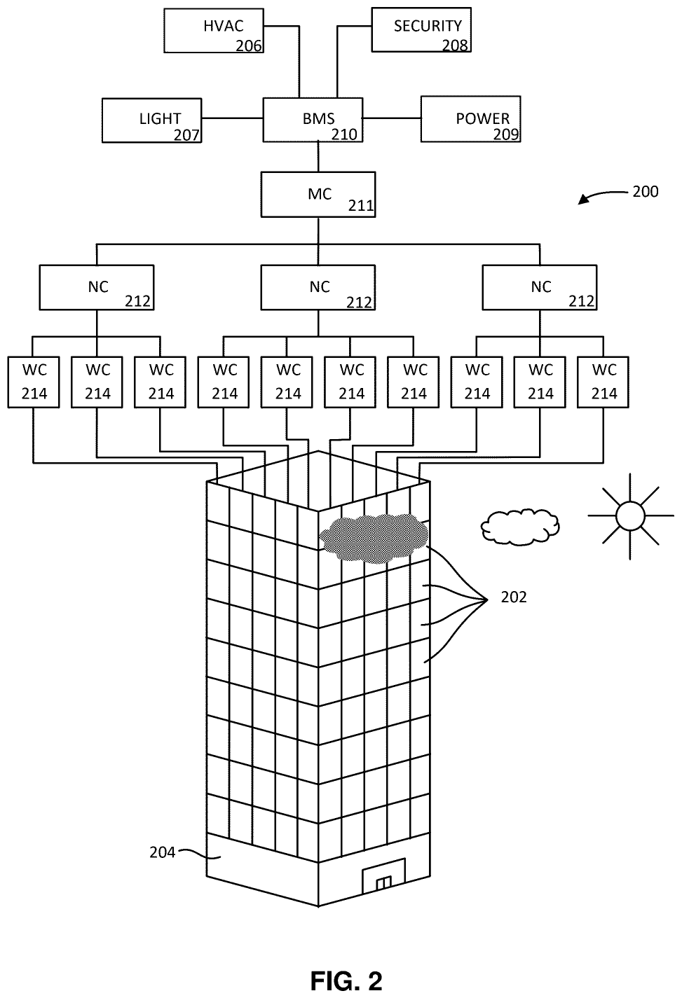

FIG. 2 shows a depiction of a system 200 for controlling and driving a plurality of optically-switchable windows. It may be employed to control the operation of one or more devices associated with a optically-switchable window such as a window antenna. The system 200 can be adapted for use with facility (e.g., a building 204) comprising a commercial office building or a residential building. In some embodiments, the system 200 is designed to function in conjunction with modern heating, ventilation, and air conditioning (HVAC) systems 206, interior lighting systems 207, security systems 208, and power systems 209 as a single holistic and efficient energy control system for the entire building 204, or a campus of buildings 204. Some embodiments of the system 200 are particularly well-suited for integration with a building management system (BMS) 210. The BMS 210 is a computer-based control system that can be installed in a building to monitor and control the building's mechanical and electrical equipment such as HVAC systems, lighting systems, power systems, elevators, fire systems, and security systems. The BMS 210 can include hardware and associated firmware or software for maintaining conditions in the building 204 according to preferences set by the occupants or by a building manager or other administrator. The software can be based on, for example, internet protocols or open standards.

A BMS can be used in large buildings where it functions to control the environment within the building. For example, the BMS 210 may control lighting, temperature, carbon dioxide levels, and/or humidity within the building 204. There can be several (e.g., numerous) mechanical and/or electrical devices that are controlled by the BMS 210 including, for example, furnaces or other heaters, air conditioners, blowers, and/or vents. To control the building environment, the BMS 210 can turn on and off these various devices, e.g., according to rules and/or in response to conditions. Such rules and/or conditions may be selected and/or specified by a user (e.g., building manager and/or administrator). One function of the BMS 210 may be to maintain a comfortable environment for the occupants of the building 204, e.g., while minimizing heating and cooling energy losses and costs. In some embodiments, the BMS 210 is configured not (e.g., only) to monitor and control, but also to optimize the synergy between various systems, for example, to conserve energy and lower building operation costs.

Some embodiments are designed to function responsively or reactively based on feedback. The feedback control scheme may comprise measurements sensed through, for example, thermal, optical, or other sensors. The feedback control scheme may comprise input from an HVAC, interior lighting system, and/or an input from a user control. Examples of control system, methods of its use, and its related software, may be found in U.S. Pat. No. 8,705,162, issued Apr. 22, 2014, which is incorporated herein by reference in its entirety. Some embodiments are utilized in existing structures, including commercial and/or residential structures, e.g., having traditional or conventional HVAC and/or interior lighting systems. Some embodiments are retrofitted for use in older facilities (e.g., residential homes).

The system 200 includes network controllers 212 configured to control a plurality of window controllers 214. For example, one network controller 212 may control at least tens, hundreds, or thousands of window controllers 214. Each window controller 214, in turn, may control and drive one or more electrochromic windows 202. In some embodiments, the network controller 212 can issue high level instructions such as the final tint state of a tintable window. The window controllers may receive these commands and directly control their associated windows, e.g., by applying electrical stimuli to appropriately drive tint state transitions and/or maintain tint states. The number and size of the optically-switchable (e.g., electrochromic) windows 202 that each window controller 214 can drive, may be generally limited by the voltage and/or current characteristics of the load on the window controller 214 controlling the respective electrochromic windows 202. In some embodiments, the maximum window size that the window controller 214 can drive is limited by the voltage, current, and/or power requirements, to cause the requested optical transitions in the electrochromic window 202 within a requested time-frame. Such requirements are, in turn, a function of the surface area of the window. In some embodiments, this relationship is nonlinear. For example, the voltage, current, and/or power requirements can increase nonlinearly with the surface area of the electrochromic window 202. Without wishing to be bound to theory, in some cases the relationship is nonlinear at least in part because the sheet resistance of the first and second conductive layers increases nonlinearly with distance across the length and width of the first or second conductive layers. In some embodiments, the relationship between the voltage, current, and/or power requirements required to drive multiple electrochromic windows 202 of equal size and shape is directly proportional to the number of the electrochromic windows 202 being driven.

FIG. 2 shows an example of a master controller 211. The master controller 211 communicates and functions in conjunction with multiple network controllers 212, each of which network controllers 212 is capable of addressing a plurality of window controllers 214. In some embodiments, the master controller 211 issues the high level instructions (such as the final tint states of the tintable windows) to the network controllers 212, and the network controllers 212 then communicate the instructions to the corresponding window controllers 214. FIG. 2 shows an example of a hierarchical control system comprising the master controller, the network controllers, and the window controllers.

In some implementations, the various electrochromic windows 202, antennas, and/or other target devices of the facility (e.g., comprising building or other structure) are (e.g., advantageously) grouped into zones or groups of zones (e.g., wherein each of which includes a subset of the electrochromic windows 202). For example, each zone may correspond to a set of electrochromic windows 202 in a specific location or area of the facility that should be tinted (or otherwise transitioned) to the same or similar optical states, based at least in part on their location. As another example, consider a building having four faces or sides: A North face, a South face, an East Face, and a West Face. Consider that the building has ten floors. In such an example, each zone can correspond to the set of electrochromic windows 202 on a particular floor and on a particular one of the four faces. In some such embodiments, each network controller 212 can address one or more zones or groups of zones. For example, the master controller 211 can issue a final tint state command for a particular zone or group of zones to a respective one or more of the network controllers 212. For example, the final tint state command can include an abstract identification of each of the target zones. The designated network controllers 212 receiving the final tint state command may then map the abstract identification of the zone(s) to the specific network addresses of the respective window controllers 214 that control the voltage or current profiles to be applied to the electrochromic windows 202 in the zone(s).

In some embodiments, a distributed network of controllers is used to control the optically-switchable windows. For example, a network system may be operable to control a plurality of IGUs in accordance with some implementations. One primary function of the network system may be to control the optical states of the electrochromic devices (or other optically-switchable devices) within the IGUs.

In some embodiments, another function of the network system is to acquire status information (e.g., data) from the IGUs. For example, the status information for a given IGU can include an identification of, or information about, a current tint state of the tintable device(s) within the IGU. The network system may be operable to acquire data from various sensors, such as temperature sensors, photosensors (referred to herein as light sensors), humidity sensors, air flow sensors, or occupancy sensors, antennas, whether integrated on or within the IGUs or located at various other positions in, on or around the building. At least one sensor may be configured (e.g., designed) to measure one or more environmental characteristics, for example, temperature, humidity, ambient noise, carbon dioxide, VOC, particulate matter, oxygen, and/or any other aspects of an environment (e.g., atmosphere thereof). The sensors may comprise electromagnetic sensors.

The electromagnetic sensor may be configured to sense ultraviolet, visible, infrared, and/or radio wave radiation. The infrared radiation may be passive infrared radiation (e.g., black body radiation). The electromagnetic sensor may sense radio waves. The radio waves may comprise wide band, or ultra-wideband radio signals. The radio waves may comprise pulse radio waves. The radio waves may comprise radio waves utilized in communication. The radio waves may be at a medium frequency of at least about 300 kilohertz (KHz), 500 KHz, 800 KHz, 1000 KHz, 1500 KHz, 2000 KHz, or 2500 KHz. The radio waves may be at a medium frequency of at most about 500 KHz, 800 KHz, 1000 KHz, 1500 KHz, 2000 KHz, 2500 KHz, or 3000 KHz. The radio waves may be at any frequency between the aforementioned frequency ranges (e.g., from about 300 KHz to about 3000 KHz). The radio waves may be at a high frequency of at least about 3 megahertz (MHz), 5 MHz, 8 MHz, 10 MHz, 15 MHz, 20 MHz, or 25 MHz. The radio waves may be at a high frequency of at most about 5 MHZ, 8 MHz, 10 MHz, 15 MHz, 20 MHz, 25 MHz, or 30 MHz. The radio waves may be at any frequency between the aforementioned frequency ranges (e.g., from about 3 MHz to about 30 MHz). The radio waves may be at a very high frequency of at least about 30 Megahertz (MHZ), 50 MHz, 80 MHz, 100 MHz, 150 MHz, 200 MHz, or 250 MHz. The radio waves may be at a very high frequency of at most about 50 MHz, 80 MHz, 100 MHz, 150 MHz, 200 MHz, 250 MHz, or 300 MHz. The radio waves may be at any frequency between the aforementioned frequency ranges (e.g., from about 30 MHz to about 300 MHz). The radio waves may be at an ultra-high frequency of at least about 300 kilohertz (MHz), 500 MHz, 800 MHz, 1000 MHz, 1500 MHz, 2000 MHz, or 2500 MHz. The radio waves may be at an ultra-high frequency of at most about 500 MHz, 800 MHz, 1000 MHz, 1500 MHz, 2000 MHz, 2500 MHz, or 3000 MHz. The radio waves may be at any frequency between the aforementioned frequency ranges (e.g., from about 300 MHz to about 3000 MHz). The radio waves may be at a super high frequency of at least about 3 gigahertz (GHz), 5 GHz, 8 GHz, 10 GHz, 15 GHz, 20 GHz, or 25 GHz. The radio waves may be at a super high frequency of at most about 5 GHz, 8 GHz, 10 GHz, 15 GHz, 20 GHz, 25 GHz, or 30 GHz. The radio waves may be at any frequency between the aforementioned frequency ranges (e.g., from about 3GHz to about 30 GHz).

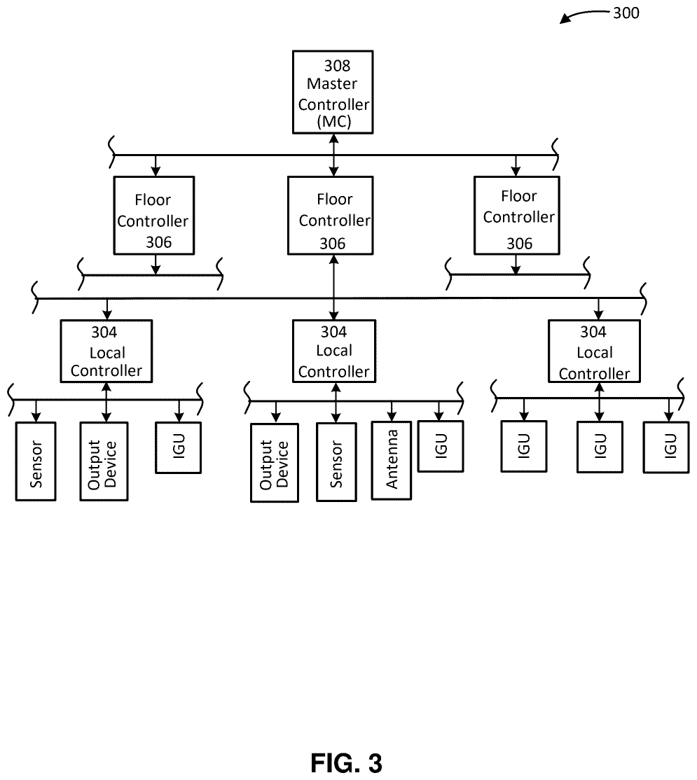

The network system may include any suitable number of distributed controllers having various capabilities or functions. In some embodiments, the functions and arrangements of the various controllers are defined hierarchically. FIG. 3 shows an example of a network system 300 including a plurality of distributed local (e.g., window) controllers (WCs) 304, a plurality of floor (e.g., network) controllers (NCs) 306, and a master controller (MC) 308. In some embodiments, the MC 308 can communicate with and control at least two, ten, tens, hundred, or hundreds of floor using floor controllers (e.g., network controllers NC) 306. The floor controller may be configured to control a floor or a portion of a floor. In various embodiments, the master controller MC 308 issues high level instructions to the NCs 306 over one or more wired and/or wireless communication links. The instructions can include, for example, tint commands for causing transitions in the optical states of the IGUs controlled by the respective NCs 306. Each NC 306 may, in turn, communicate with and control a number of window controllers (WCs) 304 over one or more wired and/or wireless links. The communication links may be bidirectional communication links.

The MC 308 may issue communications including tint commands, status request commands, data (for example, sensor data) request commands or other instructions. In some embodiments, the MC 308 issues such communications periodically, at certain predefined times of day (which may change based on the day of week or year), or based at least in part on the detection of particular events, conditions or combinations of events or conditions (for example, as determined by acquired sensor data or based at least in part on the receipt of a request initiated by a user and/or by an application or a combination of such sensor data and such a request). In some embodiments, when the MC 308 determines to cause a tint state change (e.g., alteration) in a set of one or more IGUs, the MC 308 generates or selects a tint value corresponding to the requested tint state. In some implementations, the set of IGUs is associated with a first protocol identifier (ID) (for example, a Building Automation and Control (BAC) network identification (BACnet ID)). The MC 308 may then generate and transmit a communication—referred to herein as a “primary tint command”—including the tint value and the first protocol ID over the link via a first communication protocol (for example, a BACnet compatible protocol). In some embodiments, the MC 308 addresses the primary tint command to the particular NC 306 that controls the particular one or more WCs 304 that, in turn, control the set of IGUs to be transitioned. The NC 306 may receive the primary tint command including the tint value and the first protocol ID and map the first protocol ID to one or more second protocol IDs. In some embodiments, each of the second protocol IDs identifies a corresponding one of the WCs 304. The NC 306 may subsequently transmit a secondary tint command including the tint value to each of the identified WCs 304 over the link via a second communication protocol. In some embodiments, each of the WCs 304 that receives the secondary tint command then selects a voltage and/or current profile from an internal memory based on the tint value to drive its respectively connected IGUs to a tint state consistent with the tint value. Each of the WCs 304 may then generate and provide voltage and/or current signals over the link to its respectively connected IGUs to apply the voltage or current profile.

In a similar manner to how the function and/or arrangement of controllers may be arranged hierarchically, optically-switchable windows may be arranged in a hierarchical structure. A hierarchical structure can help facilitate the control of optically-switchable windows at a particular site by allowing rules or user control to be applied to various groupings of optically-switchable windows or IGUs. Further, for aesthetics, multiple contiguous windows in a room and/or other site location may sometimes need to have their optical states correspond and/or tint at the same rate. Treating a group of contiguous windows as a zone can facilitate these goals.

In some embodiments, IGUs are grouped into zones of optically-switchable windows, each of which zones includes at least one window controller and its respective IGUs. Each zone of IGUs may be controlled by one or more respective NCs and one or more respective WCs controlled by these NCs. For example, each zone can be controlled by a single NC and two or more WCs controlled by the single NC.

In some embodiments, at least one device is operated in coordination with at least one other device, which devices are coupled to the network. Control of the at least one device may be via Ethernet. For example, A tint level of tintable windows may be adjusted concurrently. When the devices are in use, a zone of devices may have at least one characteristics that is the same. For example, when the tintable windows are in a zone, a zone of tintable windows may have its tint level (automatically) altered (e.g., darkened or lightened) to the same level. For example, when sounds sensors are in a zone, they may sample sound at the same frequency and/or at the same time window. A zone of devices may comprise a plurality of devices (e.g., of the same type). The zone may comprise (i) devices (e.g., optically-switchable windows) facing a particular direction of an enclosure (e.g., facility), (ii) a plurality of devices disposed on a particular face (e.g., façade) of the enclosure, (iii) devices on a particular floor of a facility, (iv) devices in a particular type of room and/or activity (e.g., open space, office, conference room, lecture hall, corridor, reception hall, or cafeteria), (v) devices disposed on the same fixture (e.g., internal or external wall), and/or (vi) devices that are user defined (e.g., a group of optically-switchable windows in a room or on a façade that are a subset of a larger group of optically-switchable windows. The (automatic) adjustment of the devices may done automatically and/or by a user. The automatic changing of device properties and/or status in a zone, may be overridden by a user (e.g., by manually adjusting the tint level). A user may override the automatic adjustment of the devices in a zone using mobile circuitry (e.g., a remote controller, a virtual reality controller, a cellular phone, an electronic notepad, a laptop computer and/or by a similar mobile device).

In some embodiments, when instructions relating to the control of a device (e.g., instructions for a window controller or an IGU) are passed through the network system, they are accompanied with a unique network ID of the device they are sent to. Networks IDs may be helpful to ensure that instructions reach and are carried out on the intended device. For example, a window controller that controls the tint states of more than one IGU, may determine which IGU to control based upon a network ID such as a Controller Area Network (CAN) ID (a form of network ID) that is passed along with the tinting command. In a window network such as those described herein, the term network ID includes but is not limited to CAN IDs, and BACnet IDs. Such network IDs may be applied to window network nodes such as window controllers, network controllers, and master controllers. A network ID for a device may include the network ID of every device that controls it in the hierarchical structure. For example, the network ID of an IGU may include a window controller ID, a network controller ID, and a master controller ID in addition to its own CAN ID.

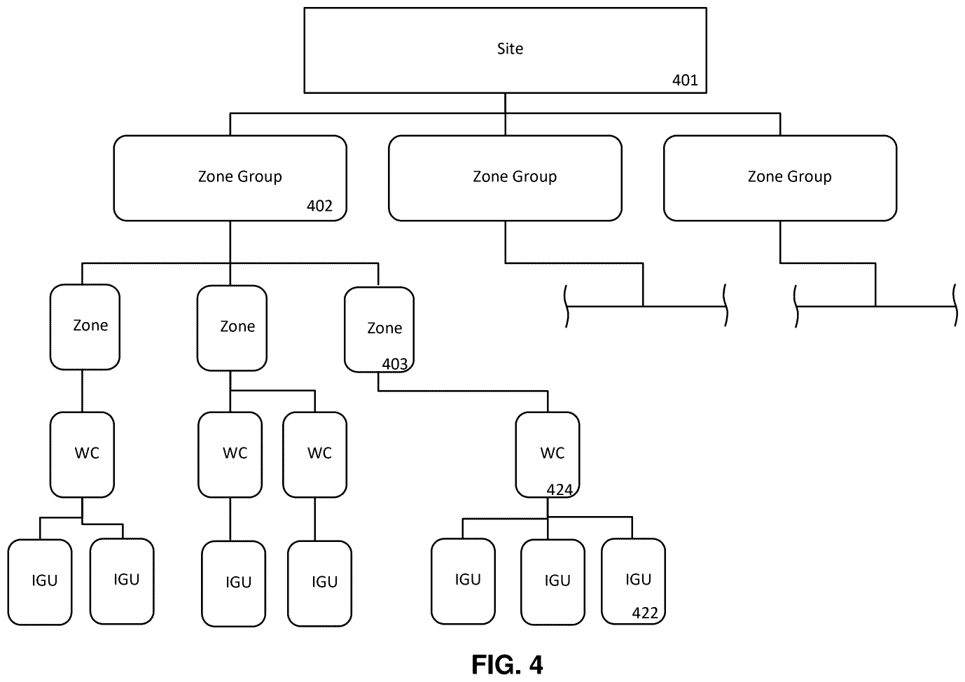

FIG. 4 shows various IGUs 422 grouped into zones 403 of optically-switchable windows, each of which zones 403 includes at least one window controller 424 and its respective IGUs 422. In some embodiments, each zone of IGUs 422 is controlled by one or more respective NCs and one or more respective WCs 424 controlled by these NCs. Each zone 403 may be controlled by a single NC and two or more WCs 424 controlled by the single NC. Thus, a zone 403 can represent a logical grouping of the IGUs 422. Similarly, a zone group 402 can represent a logical grouping of zones 403. For example, each zone 403 may correspond to a set of IGUs 422 in a specific location or area of the building that are driven together based on their location. As a more specific example, consider a site 401 that is a building having four faces or sides: A North face, a South face, an East Face, and a West Face. Consider that the building has ten floors. In such an example, each zone 403 may correspond to the set of optically-switchable windows (IGUs 422) on a particular floor and on a particular one of the four faces. Each zone 403 may correspond to a set of IGUs 422 that share one or more physical characteristics (for example, device parameters such as size or age). In some embodiments, a zone 403 of IGUs 422 is grouped based at least in part on one or more non-physical characteristics comprising a security designation or a business hierarchy (for example, IGUs 422 bounding managers' offices can be grouped in one or more zones while IGUs 422 bounding non-managers' offices can be grouped in one or more different zones).

In some such implementations, each NC can address all of the IGUs 422 in each of one or more respective zones 403. For example, the MC can issue a primary tint command to the NC that controls a target zone 403. The primary tint command can include an abstract identification of the target zone (hereinafter referred to as a “zone ID”). In some such implementations, the zone ID can be a first protocol ID such as that just described in the example above. The NC may receive the primary tint command including the tint value and the zone ID and may map the zone ID to the second protocol IDs associated with the WCs 424 within the zone. In some embodiments, the zone ID can be a higher level abstraction than the first protocol IDs. In such cases, the NC can first map the zone ID to one or more first protocol IDs, and subsequently map the first protocol IDs to the second protocol IDs.

In order for tint controls to work (e.g., to allow the window control system to change the tint state of one or a set of specific windows or IGUs), a master controller, network controller, and/or other controller responsible for tint decisions, may utilize the network address of the window controller(s) connected to that specific window or set of windows. To this end, a function of commissioning may be used to provide correct assignment of window controller addresses and/or other identifying information to specific windows and window controllers, as well the physical locations of the windows and/or window controllers in buildings. In some embodiments, a goal of commissioning is to correct mistakes and/or other problems made in installing windows in the wrong locations or connecting cables to the wrong window controllers. In some embodiments, a goal of commissioning is to provide semi-or fully-automated installation. In other words, allowing installation with little or no location guidance for installers.

In some embodiments, the commissioning process for a particular window or IGU may involve associating an ID for a device (e.g., the window and/or other window-related component), with its corresponding local (e.g., window) controller. The process may assign a building location, a relative location, and/or absolute location (e.g., latitude, longitude, and elevation) to the device (e.g., window or another component). Examples relating to commissioning and/or configuring a network of optically-switchable (e.g., tintable) windows can be found in U.S. patent application Ser. No. 14/391,122, filed Oct. 7, 2014, titled “APPLICATIONS FOR CONTROLLING OPTICALLY SWITCHABLE DEVICES,” U.S. patent application Ser. No. 14/951,410, filed Nov. 24, 2015, titled “SELF-CONTAINED EC IGU,” U.S. Provisional Patent Application Ser. No. 62/305,892, filed Mar. 9, 2016, titled “METHOD OF COMMISSIONING ELECTROCHROMIC WINDOWS,” and U.S. Provisional Patent Application Ser. No. 62/370,174, filed Aug. 2, 2016, titled “METHOD OF COMMISSIONING ELECTROCHROMIC WINDOWS,” each of which is herein incorporated by reference in its entirety.

After a network of devices (e.g., optically switchable windows) is physically installed, the network can be commissioned to correct any incorrect assignment of window controllers to the wrong windows (often as IGUs) or building locations. In some embodiments, commissioning maps pairs or links individual devices (e.g., windows) and their locations with associated location (e.g., window) controllers.

In some embodiments, commissioning is intended to address mis-pairing of local (e.g., window) controllers and associated devices (e.g., windows), for example, during installation. For example, before installation, a local (e.g., window) controller may be assigned to a particular device (e.g., window), which may be assigned to a particular location in the building. However, during installation a local (e.g., window) controller and/or devices (e.g., window) may be installed in an incorrect location. For instance, a local (e.g., window) controller may be paired with the wrong device (e.g., window), or the device (e.g., window) may be installed in the wrong location. These mis-pairings can be difficult to address and/or require substantial (e.g., manual) labor, time and/or cost to address and/or rectify. Additionally, during the construction process, the physical device (e.g., window) installation and the wiring installation in the building may be done by different teams at different times. Recognizing this challenge, in some implementations, the devices (e.g., windows) and/or local controllers are not pre-assigned to one another, but rather are paired during a commissioning process. Even if mis-pairing is not a problem because, for example, local (e.g., window) controllers are physically affixed to their corresponding devices (e.g., windows), the installer might not know or care which device (e.g., window) (and hence which local controller) is installed at which location. For example, devices (e.g., windows) may be identical in size, shape, and/or optical properties, and hence be interchangeable. The installer may install such devices (e.g., windows) at any convenient location, without regard for the unique local controller associated with each such device (e.g., window). Various commissioning embodiments described herein permit such flexible installation.

Some examples of issues that can arise during installation are the following: (I) Mistakes in placing windows in correct locations: electrically controllable windows may be susceptible to mis-installation, e.g., by technicians who are not accustomed to working with electrically controllable windows. These technicians may include tradespeople such as glaziers and/or low voltage electricians (LVE's); (II) Misconnecting cables to window controllers: this can be occur, e.g., when multiple windows are disposed in close proximity; (III) Malfunctioning (e.g., broken) optically-switchable windows and/or window controllers: An installer can install an available window and/or controller in place of the malfunctioning (e.g., broken) one. The new window and/or controller may not be in the installation and/or building (e.g., BIM) plan, and thus may not be accounted for and/or recognized during commissioning; and (IV) The process of installing many windows at the correct locations may be complicated. It would be desirable to replace the paradigm of having installers be responsible for installing many unique windows in unique locations, which installation may be prone to human error. Therefore, it could be useful to do away with (e.g., much, or all of) the window and/or controller location considerations, which can complicate the installation process. A similar discussion can apply for any device (substituting the window), and any local controller that controls the device (substituting the window controller). The device can by any device, e.g., as disclosed herein.

In one example, installation and attendant problems requiring improved methods of commissioning may arise from the following operations:
a. A unique network address (e.g., a CANID) is assigned to each window controller when the window controllers are manufactured.
b. The window manufacturer (that is not necessarily the window controller manufacturer), a building designer, or other entity, specifies information about the window controller (with specified network address) and window (IGU). It does this by assigning a window controller ID (WCID), which is not (e.g., which differs from) the window controller's network address. The window manufacturer and/or other entity specifies which IGU(s) are associated with the window controller (WCID). To this end, the entity specifies window IDs (WIDs) for the windows. In certain cases, the manufacturer and/or other entity does not specify a correlation between IGU and controllers, e.g., to which specific IGU(s) a controller needs to be connected. For example, the window manufacture need not specify that a WC (with a CANID (e.g., 19196997)) needs to connect to any particular WID (e.g., 04349'0524'0071'0017'00). Instead, the manufacturer or other entity specifies that a WC (with CANID (e.g., 19196997)) has a window controller ID of, e.g., WC10. The window controller ID may be reflected (e.g., appear) as a location tag (e.g., an arbitrary number assigned to windows in an installation) on an interconnect drawing, architectural drawing, or other representation of a building, which may specify that the window controller connects to particular IGUs identified by window IDs (e.g., W31 and W32 (location tag for IGs)).
c. As indicated, the manufacturer or other entity applies a window controller ID (WCxx label) on each window controller. The entity enters a WCxx/CAN ID pair information in a configuration file used by master controller/network controller or other device containing logic responsible for issuing individual tint decisions.
d. This process requires that an LVE or other technician charged with installing and/or connecting electrically controllable windows to select a specific window controller from the boxes of window controllers and install it in a specific location in the building.
e. Any errors made in operations (c) or (d) lead to difficult troubleshooting in the field to find the mis-mapping and correct it.
f. Even if operations (c) and (d) are executed correctly, a window controller and/or window can be damaged, in which case it must be replaced during the installation. This again can cause problems unless the change is tracked manually and reflected in the configuration file. A similar discussion can apply for any device (substituting the window), and any local controller that controls the device (substituting the window controller). The device can by any device, e.g., as disclosed herein.

The local controllers may directly control the device, may be located on or proximate to the device (e.g., may be located on the window or device ensemble housing or proximate to). In some embodiments, a commissioning process specifies the type of controller in a hierarchical network and/or the logical position of the controller in that network's topology. Each individual device (e.g., sensor, device ensemble, and/or optically switchable window) may have a physical ID (e.g., the window or lite ID (WID) mentioned herein) and an associated controller with a unique network ID (e.g., the above-mentioned CANID). In some embodiments, the local controller includes a physical ID (e.g., the WCID). In general, a commissioning process may be used to link or pair any two related network components including but not limited to IGUs (or lites in IGUs), window controllers, network controllers, master controllers, sensors, emitters, antenna, receivers, transceivers, processors, and/or device ensembles. In some embodiments, the commissioning process involves pairing network identifiers associated with devices (e.g., IGUs) and/or controllers, to fixtures, surfaces and/or any other features on a three-dimensional building model (e.g., BIM file). Device ensembles may be referred to herein as “digital architectural element.”

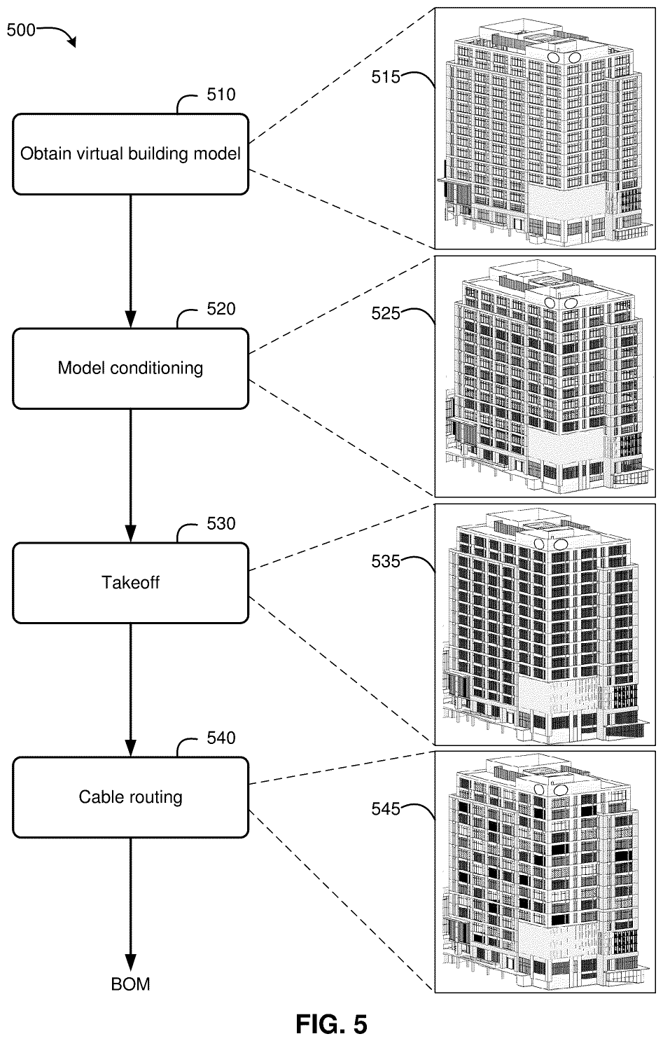

As previously indicated, some embodiments may streamline the takeoff and/or cable routing processes by implemented in various operations on a virtual model of an building or other enclosure. Takeoff and/or cable routing may be part of a process for obtaining a bill of materials (BOM) from a virtual model of an enclosure. According to some embodiments, windows and controllers described with respect to FIGS. 5-18 may respectively correspond with IGUs and the local controllers (e.g., IGUs and local controller 304 of FIG. 3) as previously described with respect to FIGS. 1-4.

FIG. 5 is a flow diagram of a process 500 for obtaining a BOM for building, according to an embodiment. As with other figures herein, FIG. 5 is provided as a non-limiting example, and alternative embodiments may employ various alterations to the process 500 illustrated in FIG. 5, and may be implemented for types of enclosures in addition or as an alternative to buildings. The process 500 may the executed by a computer, for example, using a CAD software program. The functionality illustrated in the blocks of the process 500 may be implemented by the CAD software program itself, or using plug-ins, extensions, or scripts (or combination thereof) within the CAD software.

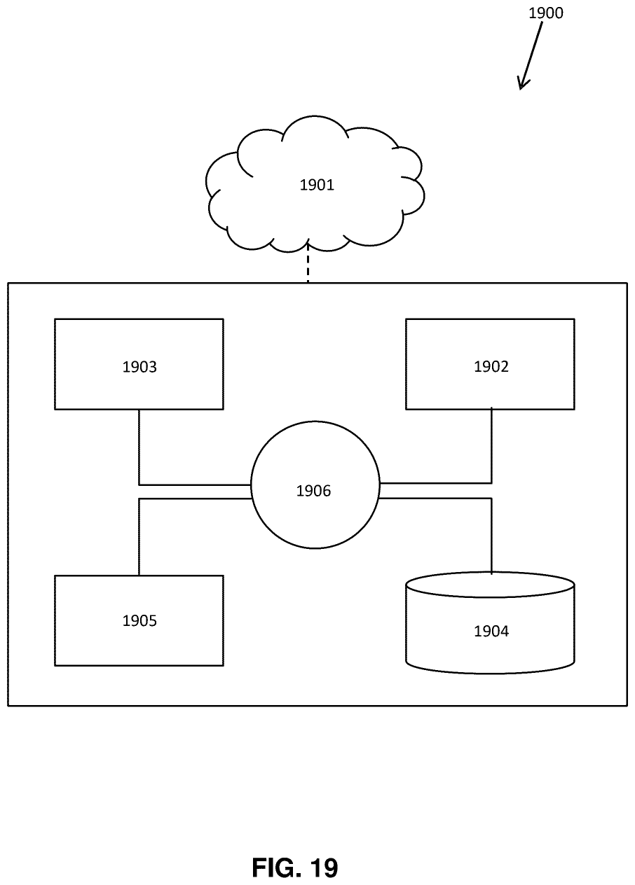

At block 510, the functionality comprises obtaining a virtual building model. As noted, a virtual building model may comprise virtual representation of the enclosure. A CAD program executed by a computer system (e.g., as shown in FIG. 19 and described hereafter) may be used to obtain and read the electronic file (e.g., from a file storage medium) and display the virtual building model. A visualization of an example virtual building model, which may be shown on such a display, is illustrated in box 515.

Depending on the type of virtual building model used, the model may comprise different components. For example, in some embodiments, a model may be made of different components, or elements, which may comprise individual or groups of building features. Each window, for example, may comprise a different element, although (depending on how the virtual model was created) some virtual models may group together various elements. As such, some embodiments may “un-group” all elements in a virtual model to eliminate grouping and ensure elements comprise basic components. An element may belong to a category (e.g., window, wall, etc.), belong to a family (e.g., the family of elements that constitute a larger component, such as a family of smaller windows that constitute a storefront double window, storefront single window, curtainwall, etc.), may be of a certain type (e.g., having common properties, such as dimensions, materials, etc.), or a combination thereof. Properties of an element, such as material, may further comprise characteristics or attributes. Transparency, for example, may be an attribute of a material (e.g., glass) of an element (e.g., window). Again, the types of components of a virtual model may vary, depending on the type of model used, electronic file formatting, etc.

Depending on desired functionality, a user may be able to view and manipulate the virtual building model in various ways. For example, a building may be shown as a 3D model (e.g., as shown in box 515), at a user may be able of manipulating the view by panning, tilting, rotating, zooming, or any combination thereof. Further, a user may be able to select (e.g., by clicking on the element with a mouse cursor) individual elements to display various aspects of the element, such as materials the element, families to which the family belongs, categories to which the family belongs, or a combination of.

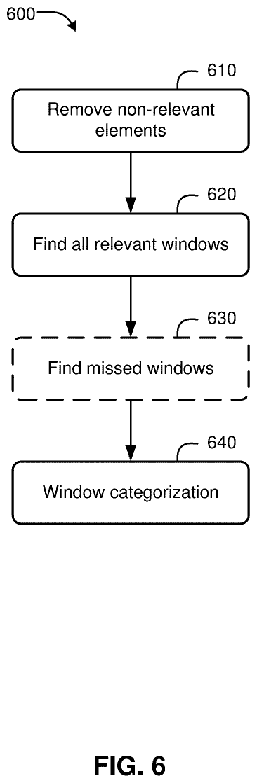

Once the virtual building model is obtained, the process 500 can then proceed to model conditioning, as indicated at block 520. As explained in more detail hereafter, model conditioning may comprise preparing a model for the takeoff process. This can involve operations such as identifying relevant model elements (e.g., windows), removing non-relevant model elements, categorizing windows, or combination thereof. Additional details regarding model conditioning are provided hereafter with regard to FIGS. 6-8. Depending on desired functionality, embodiments may enable different window categories to be displayed differently to a user, for easy visual identification by a user. An example of this is provided in box 525, where (e.g., among other categories) windows are categorized by level, and windows of different levels of the virtual model of the building are colored or shaded differently.

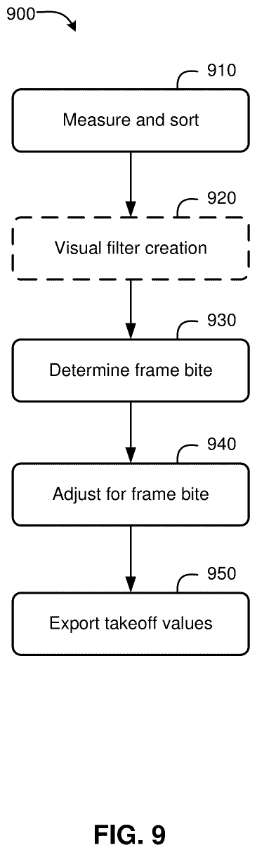

At block 530, the process 500 includes takeoff. Depending on desired functionality, takeoff may include operations such as measuring and sorting windows, determining frame bite, adjusting for frame bite, creating visual filters, exporting takeoff values, or combination thereof. Additional details regarding takeoff are described hereafter with regard to FIGS. 9-12. Ultimately, the takeoff can provide information (e.g., for a BOM) regarding at least a subset of windows of a building or other enclosure (e.g., external windows comprising the building envelope). This information can be used, for example, by a window manufacturer to determine the number and types of windows for the building. Further, as illustrated in box 535, embodiments may provide a visualization of the windows identified for takeoff, distinguishing the windows from other elements of the building (e.g., via shading, coloration, patterns, or a combination thereof).

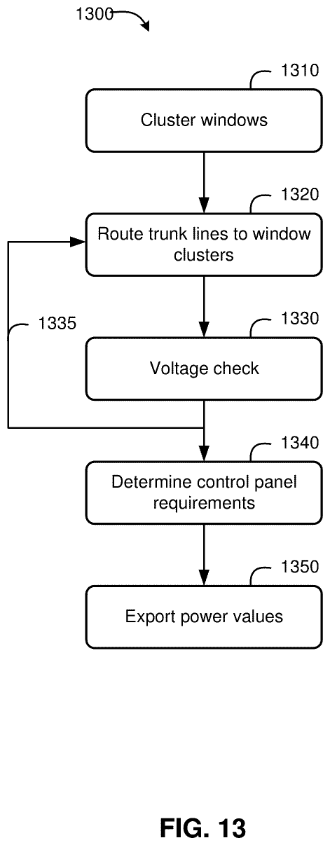

At block 540, the process 500 may comprise cable routing. As previously noted, windows such as optically-switchable windows may use electricity to power their functionality. Therefore, according to some embodiments, cables providing power (and optionally data) may be routed from a power source (e.g., a control panel) to the various windows. The cable routing at block 540 may comprise operations that enable for the creation of a plan and/or list of materials for such cable routing. As described in more detail hereafter with regard to FIGS. 13-16, these operations may include clustering windows, routing cables, performing voltage checks, determining control panel requirements, exporting power values, or a combination thereof.

After takeoff at block 530 and/or cable routing at block 540, process 500 may then output related information, such as a BOM including the windows identified during takeoff at block 530 and/or cables identified during cable routing at block 540.

FIG. 6 is a flow diagram of a method 600 for model conditioning, according to an embodiment. The functionality illustrated in the blocks of FIG. 6 may correspond to, for example, model conditioning at block 520 of FIG. 5. Moreover, the functionality may be performed, for example, using a plug-in, extension, script, or combination thereof, executed in a CAD software program in which a virtual building model can be manipulated. As described herein, the method 600 may be fully automated, or may utilize user input.

At block 610, the method 600 comprises removing non-relevant elements from the virtual model. Because a virtual model of a building can have a relatively high amount of detail that may not be relevant to takeoff, it can have an unnecessarily large file size that may use a large amount of memory of a computer performing the method 600. This may slow down operations on the model. The removal of non-relevant elements (e.g., light fixtures, HVAC components, internal glass elements, etc.) can help reduce the file size of the model (e.g., creating a “lite” version of the model that can be used for performing takeoff and/or cable routing, as described herein) and speed up the overall process.

According to some embodiments, non-relevant elements may be identified by location within the virtual model. For example, for projects in which takeoff involves windows comprising the envelope (or “skin”) of a building, this may mean removal of elements located inside the building from the virtual model. According to some embodiments, removing non-relevant elements at block 610 may therefore comprise removing elements in the virtual model of the building that are beyond a threshold distance (e.g., 1 m, 3 m, 5 m, 10 m, etc.) from an outer wall of the building. Additionally or alternatively, removing non-relevant elements may comprise removing elements within a threshold (e.g., horizontal) distance (e.g., 1 m, 3 m, 5 m, 10 m, etc.) from the (e.g., horizontal) center of the building.

Depending on desired functionality and/or user preference, the process of removal of non-relevant elements may retain certain non-window elements of a virtual building model. For example, certain elements may be retained to allow a user to identify windows relevant to the takeoff process. This may mean, for example, retaining elements of external walls, the roof, or the like to allow a user to identify, in a visualization of the retained elements of the virtual model, where external windows are in relation to the building as a whole. (An example visualization in which external elements are retained in this manner is provided in 525 of FIG. 5.)

Additionally or alternatively, non-relevant elements may be identified by category. In some instances, elements within a virtual model may be categorized based on element type. Thus, according to some embodiments, an interface may be provided to a user to enable a user to identified non-relevant categories. Non-relevant categories may include categories comprising or associated with light fixtures, HVAC components, electrical components, or the like, which may be easily identifiable by a user. The user can then identify non-relevant categories and/or relevant categories to the takeoff, and a computer can utilize this user input to remove non-relevant categories. According to some embodiments, before removal, the user interface may provide the user with a visualization of identified elements (e.g., relevant or non-relevant elements, based on categories identified by the user), which may be identified by shading, coloration, patterns, or a combination thereof (e.g., similar to the examples in boxes 525, 535, and 545 of FIG. 5), for example. This visual identification provided to the user may allow a user to confirm non-relevant elements to remove and/or relevant elements that will not be removed.

At block 620, the method 600 comprises finding all relevant windows in the virtual model of the building, which may occur subsequent to the removal of non-relevant elements at block 610. According to some embodiments, because non-window elements of a building may still be retained model, a filtering process may be used to identify the elements of the virtual model comprising windows relevant to the takeoff process. This filtering may be based, for example, on attributes of materials from which elements are comprised, categories in which elements are included (e.g., window, wall, etc.), one or more other element characteristics, or combination thereof.

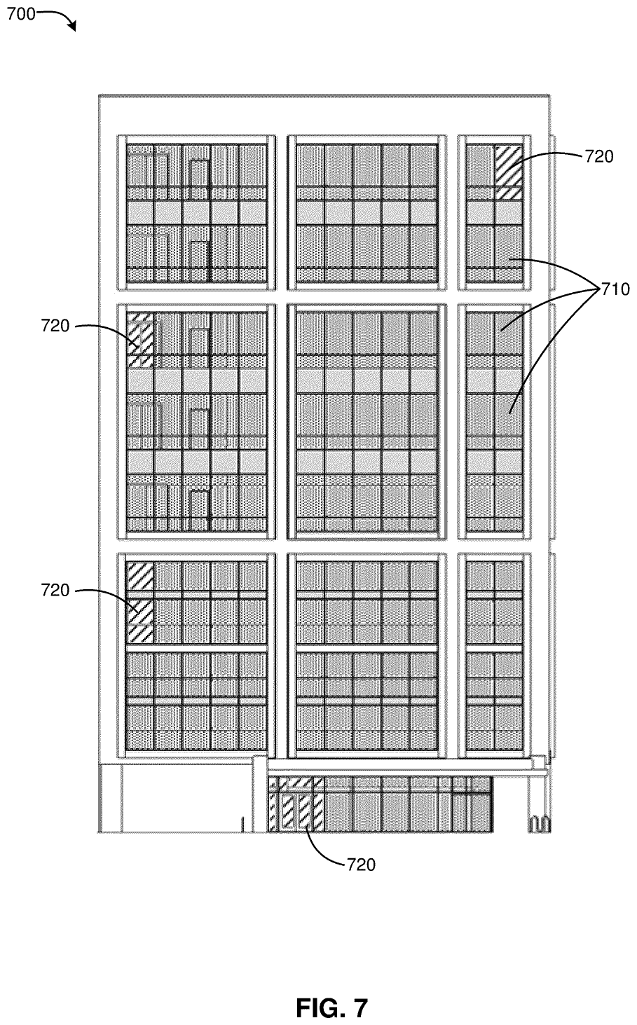

Optionally, as indicated with dashed lines at block 630, the method 600 may include finding relevant windows that were missed in the find all relevant windows operation performed at block 620. Functionality at block 630 may comprise providing a user with the visualization, enabling the user to manually select and add missed windows. In some embodiments, the find missed windows operation at block 630 may be part of a user verification operation in which the user verifies relevant windows for takeoff. An example of a visualization for such verification is shown in FIG. 7.

FIG. 7 is a simplified profile view of an example visualization of a virtual model of a building 700. In this example, identified windows 710 (only a portion which are labeled in FIG. 7, to avoid clutter) comprising elements identified as relevant windows during the find all relevant windows operation (block 620 of FIG. 6), are indicated as such in the visualization of the building 700 (e.g., using shading, coloration, pattern, etc.). In this way, a user may be able to identify missed windows 720. These missed windows 720 may be identified by a user as windows not having the identifying feature (e.g., shading, coloration, patterns, or a combination thereof) of the identified windows 710.

Additionally or alternatively, embodiments may identify building elements (e.g., using shading, coloration, patterns, or a combination thereof, different than the identified windows 710) that were unable to be identified using the algorithm for finding relevant windows (e.g., as performed at block 620 of FIG. 6). For example, if elements are identified as being relevant windows using a certain material property of an element (e.g., glass), a script may flag elements for review by a user (e.g., in a visualization similar to FIG. 7 and/or using a table or other text interface showing on properties), where the flag elements comprise elements having unknown materials, comprising multiple materials, or missing the material property. In this manner, a user can properly identify missed windows (and optionally other element types) for takeoff. According to some embodiments, a user interface can enable a user to then mark or tag a flagged element as being a relevant window, correct any element data that may have caused the element to be flag, perform other operations on the element, or combination thereof.

Returning to FIG. 6, the method 600 may then proceed to the operation of window categorization, as shown at block 640. In this operation, identified windows may be categorized into different window types. This can enable facilitate future operations in which identified windows are sorted or otherwise manipulated by category.

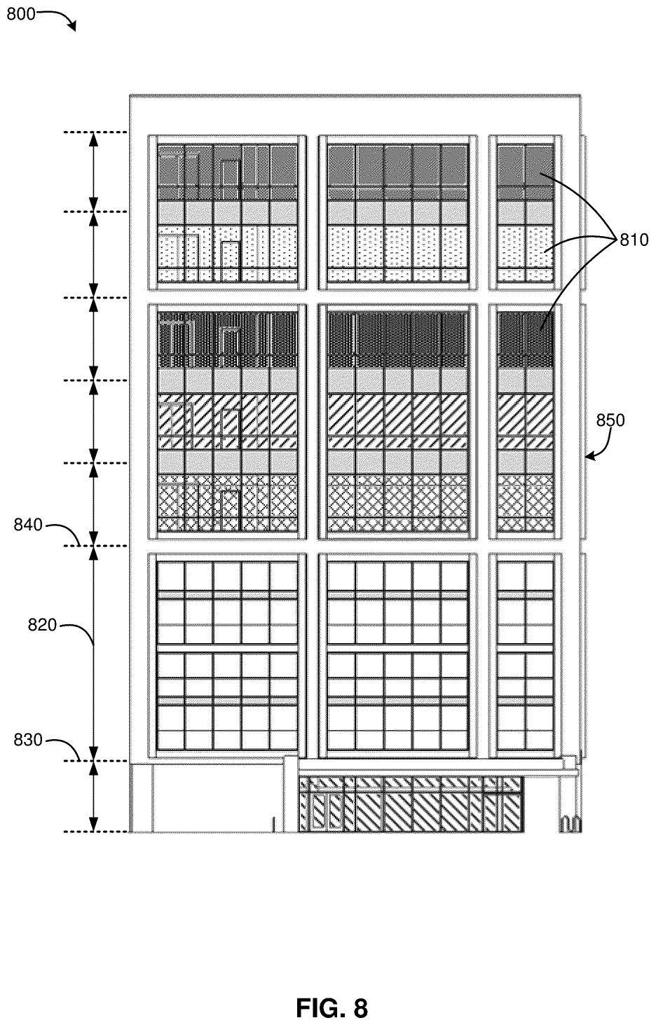

The categories into which identified windows are sorted may vary, depending on desired functionality. FIG. 8, for example, illustrates another profile view of an example visualization of a virtual model of a building 800. Here, windows 810 may be categorized by level. (Note: only a few windows in FIG. 8 are labeled.) That is, different levels of the virtual model of the building 800 may be defined, for example, as a range (e.g., range 820) of vertical positions between a lower horizontal plane (e.g., plane 830) and an upper horizontal plane (e.g., plane 840). (Other ranges and horizontal planes are illustrated in FIG. 8, but unlabeled to reduce clutter.) Some levels may not be in the scope of a given takeoff project, for example, and thus categorizing relevant windows by level can enable quick removal of windows in those levels, prior to takeoff. Horizontal planes (e.g., planes 830 and 840) defining different levels often may be readily obtained from a virtual building model. Otherwise, they may be determinable by a user, who, according to some embodiments, may define the height of each of the planes defining different levels. Once a range (e.g., range 820) is defined for the various levels within a virtual model of a building, windows may be categorized as belonging to a particular level based on whether a center point of each window is located within the range.

According to some embodiments, orientation may also be a way in which windows are categorized. FIG. 8, for example, windows on surface 850 may be categorized as having a different orientation in windows 810. Orientation may be helpful, for example, because windows of orientations may have different glazing/tinting, depending on their orientation with respect to the sun. The orientation for each window may be determined, for example, by determining a vector perpendicular to a center point on the plane defined by the planar glass of the window. The orientation of the vector can represent the orientation of the window. (The vector may be defined as being a few feet long, in which case, if the end of the vector is determined to be inside the building 800, then the vector can be “flipped” in the opposite direction to ensure the orientation of the window is facing outward, rather than inward, from the building.)

The granularity of the orientation of windows in a building may vary, depending on desired functionality. According to some embodiments, windows may be grouped into orientation categories representing cardinal directions (e.g., cast, north, west, south). According to some embodiments, windows may be grouped into different orientation categories, where windows are within a range of degrees within each other (e.g., within 5°, 10°, 20°, 30°, 45°, 60°, 90°, etc.). The orientation directions, range of degrees used for categorizing different window orientations, other aspects of orientation, or any combination thereof, may be definable by a user, according to some embodiments.

Depending on desired functionality, the window categorization at block 640 of the method 600 may include additional or alternative categories to those previously described. For example, some categories may include groupings by building (e.g., in embodiments in which a single BIM file comprises multiple buildings), type, manufacturer, phase of construction, material, or combination thereof. Some embodiments may categorize windows by size and/or shape, although, as noted hereafter, a determination of size and/or shape of windows may be performed subsequently, as part of the takeoff process.

FIG. 9 is a flow diagram of the method 900 of performing takeoff, according to an embodiment. Broadly put, this method 900 may comprise The functionality illustrated in the blocks of FIG. 9 may correspond to, for example, takeoff at block 530 of FIG. 5. Similar to the method 600 of FIG. 6, the functionality may be performed, for example, using a plug-in, extension, script, or combination thereof, executed in a CAD software program in which a virtual building model can be manipulated. As described herein, the method 900 may be fully automated, or may utilize user input.

The method 900 may begin with the functionality at block 910, in which windows (e.g., as identified in a model conditioning process such as method 600 of FIG. 6) are measured and sorted. According to some embodiments, this may comprise an automated process in which windows are categorized into groups having the same (or substantially similar) dimensions. This categorization can be performed, for example, by analyzing the dimensions of each window in the virtual building model. For a given window, if the dimensions match dimensions of an existing group, the window may be placed into that group. If the dimensions are unique, a new group can be created so that a subsequently-analyze window can be added to group if its dimensions match those of the new group. According to some embodiments, this categorization of windows can be based on features in addition or as an alternative to dimensions, such as whether windows are optically switchable or standard (non-switchable), a glazing type, a glass type, or a combination thereof.

Some embodiments may enable a user to set rules to identify or tag different window groups, based on manufacturing limitations. For example, window groups having dimensions that exceed manufacturable thresholds (e.g., too large or small, too thick or thin, etc.), and/or have a shape that is not manufacturable, can be identified as not manufacturable. As such, embodiments may enable a user to set rules to identify or tag window groups as being manufacturable or not by setting dimension-related thresholds on sizes and/or shapes (e.g., defining ranges for height, width, thickness, or combination thereof; setting rules for a minimum number of 90° angles, or the like). Window groups can then be identified as being manufacturable or not by applying these rules to each window group. Some embodiments may further allow categorization of manufacturable window groups as being “standard” or “non-standard” using similar rules for defining how manufacturable windows may be identified as standard and/or non-standard. The user may similarly implement rules-based identification or tagging of windows that do not meet certain constraints to function properly.

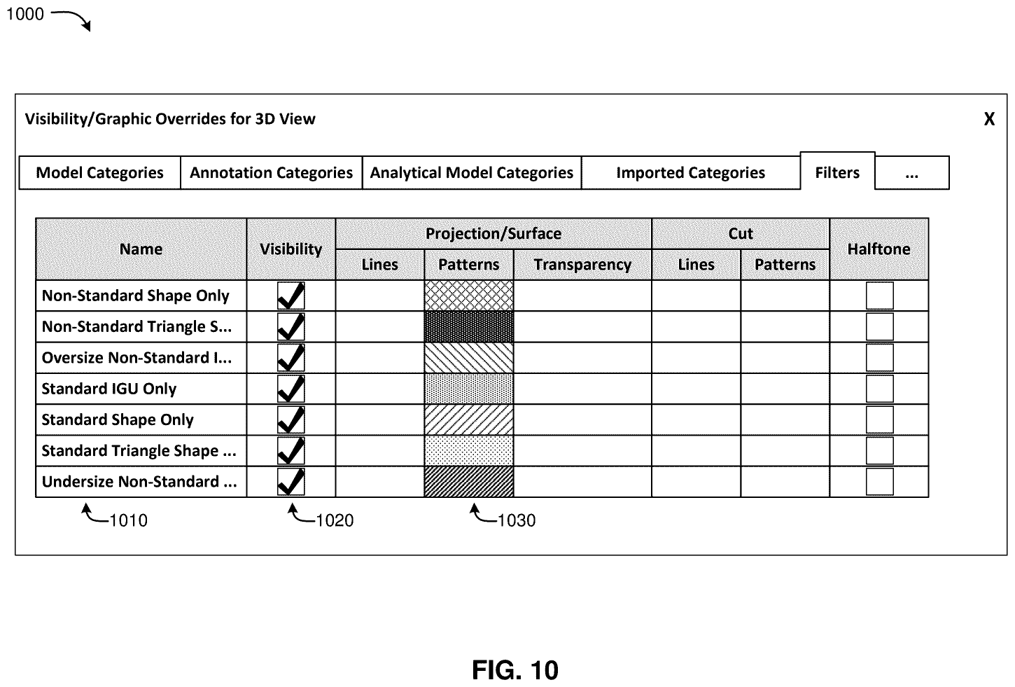

Optionally, some embodiments of the method 900 may include a visual filter creation, as shown at block 920. This functionality can enable user to apply one or more filters to a visualization of the virtual model of the building, enabling a user to visually identify windows, based on the categorization performed during the measure and sort at block 910. For example, as shown in FIG. 10, a user may be provided with a graphical interface 1000 in which a user is provided a description of different window groups (e.g., column 1010) and can select (e.g., using checkboxes in column 1020) whether a particular group is shown in a visualization of the virtual model of the building. The user may also be provided with an indication of one or more characteristics of the visualization of the various window groups. This may include, for example, a unique pattern (e.g., as shown in column 1030) used to identify each group. Additional or alternative characteristics may be used (e.g., shading, color, patterns, etc.), and, according to some embodiments, a user interface may allow a user to customize these visualization characteristics for each group.

Returning to FIG. 9, the method 900 may further comprise determining frame bite, as indicated at block 930. The frame bite determination functionality may comprise identifying groups for which a frame bite applies. As noted, this can help ensure the takeoff process does not raise the total glass needed to construct a building. As previously noted, frame bite may include the portion of a window in which a glass panel overlaps with a support structure, such as a mullion. However, frame bite may not apply to certain types of overlap. For example, for overlap in which the glass panel is in front of the support structure (e.g., from the perspective of a viewer outside the building), frame bite may not apply and the existing dimensions of the window group (e.g., as determined with the measure and sort operation at block 910) may accurately reflect the amount of class for the windows of the window group. However, for overlap in which the glass panel is behind support structure, frame bite may need to be determined and accounted for. As such, some embodiments may enable review by a user to determine whether frame bite applies to particular window groups.

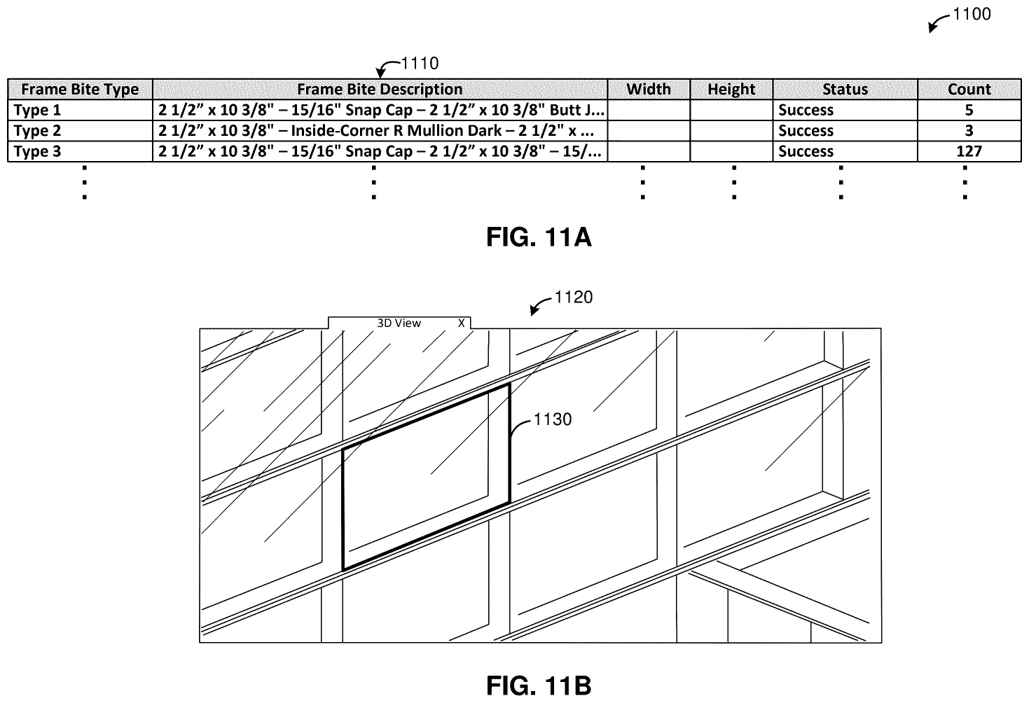

FIGS. 11A and 11B are illustrations showing information that may be provided to a user (e.g., via a graphical user interface) to enable a user to determine whether frame bite applies. According to some embodiments, window groups may be categorized based on the type of glass panel/support structure overlap window groups have, and the user may be provided with a table 1100 in which a description of each type of overlap is provided (e.g., as shown in column 1110).

Further, as shown in FIG. 11B, user may also be provided with a visualization 1120 of the building with which users may be able to visually determine whether frame bite applies. In some embodiments, for example, a user may select a frame bite type in the table 1100, and corresponding windows having the frame bite type may be highlighted in the visualization 1120, as shown with the highlighting 1130. (Additionally or alternatively, a user may select a window in the visualization 1120, and the corresponding frame bite type can be highlighted in the table 1100.) In this manner, a user may be able to visually inspect the type of overlap for each frame bite type to verify whether frame bite applies. If frame bite does not apply, embodiments can allow user to remove a frame by type from the table 1100 or otherwise flag the frame by type to be excluded from frame bite determination.

According to some embodiments, a user may be able to modify amount of frame bite for a given frame bite type. For example, if a particular frame bite type identifies frame bite in the overlap a glass panel with vertical support structures, but a user determines that additional frame bite applies for overlap of the glass panel with horizontal support structures, a user may be able to adjust the overlap for the corresponding frame bite type (e.g., in table 1100) to account for the additional overlap.

Returning to FIG. 9, the method 900 may that include adjusting for frame bite, as indicated at block 940. In this operation, the dimensions for glass panels of windows measured in the measure and sort operation of block 910 to account for the glass in a frame bite. In some embodiments, this may comprise automatically including the dimensions of the overlap, which may be included in the frame bite description in column 1110 of table 1100. Additionally or alternatively, the graphical user interface may allow user to manually input the amount of additional glass for each frame bite.

The method 900 may further comprise exporting takeoff values, as indicated at block 950. According to some embodiments, the values provided at takeoff may be user selectable. That is, embodiments may allow a user (e.g., via a graphical user interface) to input and/or select values to be exported during takeoff. These values can include, for example, a number and/or type(s) of material(s) (e.g., glass, spandrel, frit) for windows identified for takeoff, a breakdown of categories in which windows are grouped (e.g., by shape, dimension, standard/nonstandard identification), total values for each category (e.g., number of units, total square feet), total values for all windows identified for takeoff (e.g., total volume, square feet, number of units), or combination of.

These values can be exported in different ways, depending on desired functionality. For example, a computer executing the method 900 may export values by providing the values at a user interface, communicating the values to another device (e.g., directly or via the Internet), communicating the values to an application executed at the computer, or a combination thereof. Further, values may be provided via a file (e.g., comma separated value (CSV) file, Microsoft® Excel® file, HTML file, XML file, etc.), stream, or other format, or combination thereof. According to some embodiments, the way in which values are exported may be user configurable.

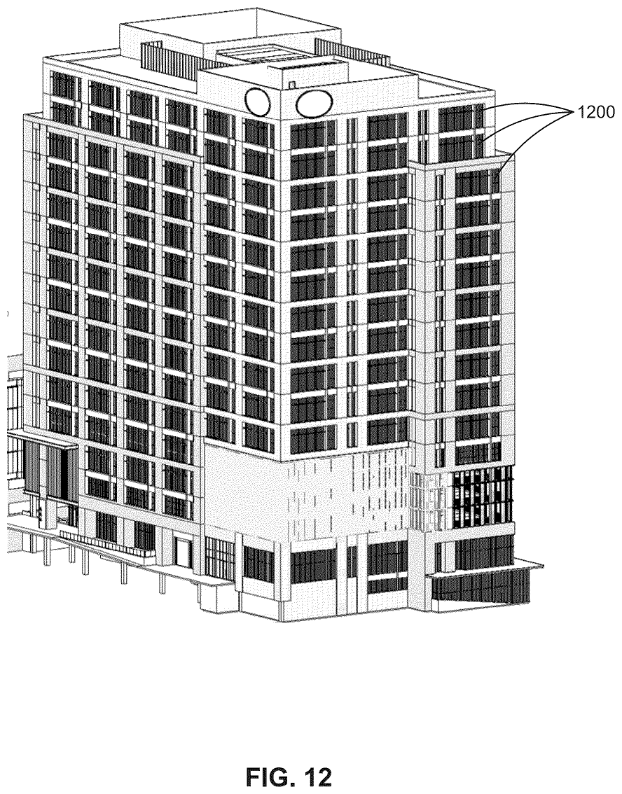

Further, some embodiments may enable a user to visually inspect a virtual model of a building prior to generating and exporting takeoff values. FIG. 12, for example, illustrates an example visualization of a virtual model of a building. In this example, windows 1200 for which takeoff values will be exported may be identified using shading, coloration, patterns, or a combination thereof. This can enable a user to identify windows for takeoff, spot any windows that may be inadvertently included and/or omitted, or the like. According to some embodiments, a user may manually select one or more windows within the visualization to include or omit from the takeoff process. Some embodiments may further allow user to modify the visualization such that different categories of windows are identified differently (e.g., using an interface similar to that shown in FIG. 10.

FIG. 13 illustrates a flow diagram of a method 1300 for cable routing, according to an embodiment. As previously noted, cable routing (the routing of cables carrying data and/or power) may be part of a larger process for obtaining a BOM for building. An thus, the method 1300 may correspond with functionality of block 540 in the process 500 of FIG. 5. Further, the functionality illustrated in the blocks of the method 1300 may be implemented CAD software or using plug-ins, extensions, or scripts (or combination thereof) within CAD software.

The cable routing process of method 1300 can be used to route trunk lines, comprising relatively large cables, from a control panel to a cluster of windows. Additional, relatively smaller cables, which may be referred to as “drop lines,” may be run from the larger cables to each window (and optionally each window controller) in the cluster. According to some embodiments, the cable routing process may be limited to the routing from client. In alternative embodiments, cable routing can additionally include the routing of drop lines.

The method 1300 may begin with the clustering windows, as indicated at block 1310. In some embodiments the method 1300 may follow takeoff (e.g., the method 900 of FIG. 9), and thus windows relevant to a construction project for which a BOM is to be obtained may already be categorized. As part of the categorization, windows for which power is needed (e.g., optically-switching windows) can be identified. In some embodiments, these windows may be identified in a visualization provided to a user. Additionally or alternatively, embodiments may enable user to select windows of a virtual model of a building for which cables are to be routed.

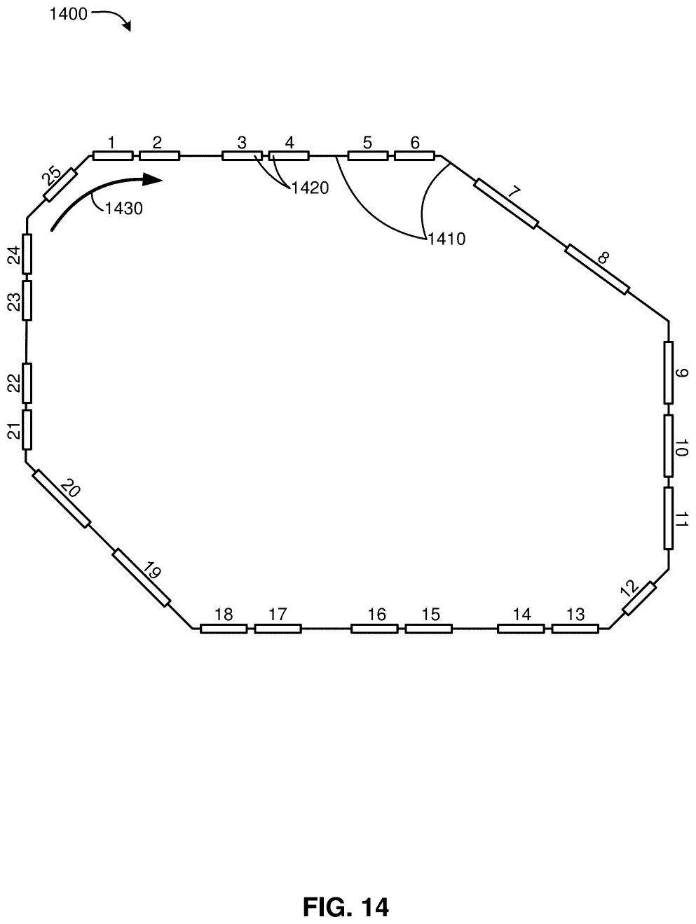

FIG. 14 is an illustration of a floor plan 1400 comprising the outer walls 1410 of a level of a virtual model of a building, including windows 1420 to which cables are to be routed. (To avoid clutter, only a small portion of the walls 1410 and windows 1420 labeled.) According to some embodiments, a visualization of the floor plan 1400 may be provided to a user in a graphical user interface. The floor plan may be derived from a virtual model of a building as described herein. Moreover, the virtual model may include additional information such as structural information, structural dimensions, and information such as the identifiers of various components depicted.

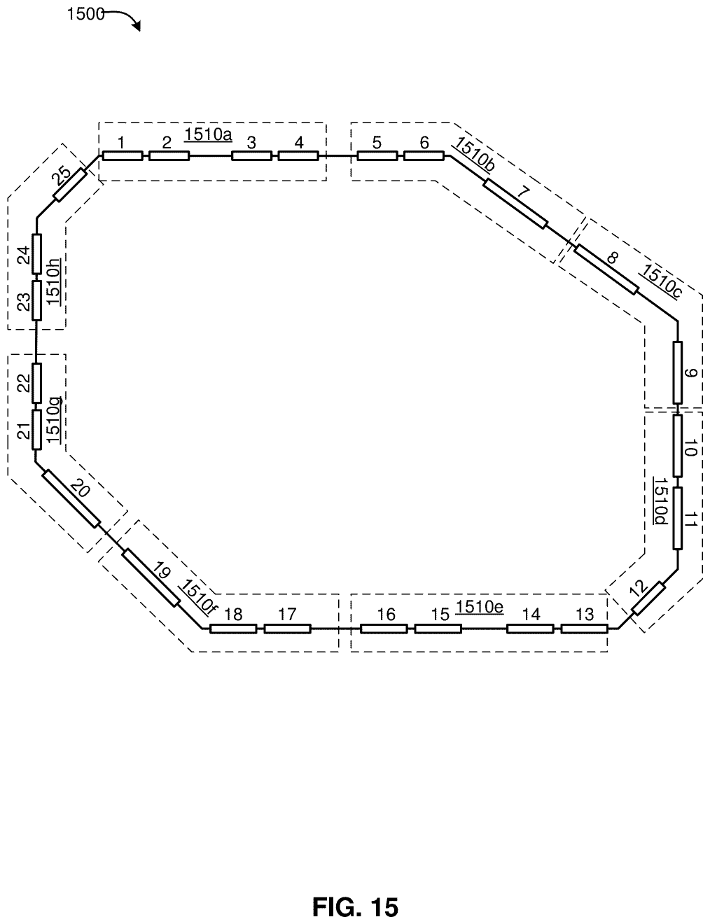

According to some embodiments, for each level of a building, windows of the virtual model of the building may be clustered by first ordering the windows, such as in the manner illustrated in FIG. 14. In the example of FIG. 14, windows are given in order based on their position in the virtual model, starting at window 1 and moving clockwise (as shown by arrow 1430) around the building until the last window, window 25, is given a number. Once the ordering is complete, clustering may further comprise the grouping of windows into clusters, as shown in FIG. 15.

In FIG. 15, which shows the updated view 1500 of the floor plan 1400 of FIG. 14, windows are grouped into clusters 1510a-1510h (indicated by dashed lines). Here, power requirements for each window can be determined based, for example, on various known parameters for a given window, such as size (e.g., width×height), and window clusters can be formed based on these determined power requirements. For example, according to some embodiments, window clusters 1510a-1510h can be made by beginning with the first window, window 1, and adding windows, in order, to the cluster comprising the first window until and maximum power threshold is exceeded. If the addition of a new window to a cluster exceeds the maximum power threshold, a new group can be formed, and windows can be added to the new group, and new groups can be formed, in a similar fashion.

In the example of FIG. 15, for instance, windows 2-4 are added to a first window cluster 1510a comprising window 1 without exceeding the maximum power threshold. The addition of window 5 exceeded the maximum power threshold for the first window cluster 1510a, and therefore a second window cluster 1510b is formed comprising window 5. Subsequent windows are then added to the second window cluster 1510b until the maximum power threshold is again exceeded, and a new cluster 1510c is formed in the same manner as the second cluster 1510b.

The maximum power threshold may comprise a maximum power a trunk line is capable of providing, which may be specified by a user. As described hereafter, because the length of a given trunk line may impact the maximum power it is capable of providing, a subsequent voltage check may be used to verify the power requirements of various clusters. Accordingly, a user may select a maximum power threshold that reflects a relatively long cable (e.g., having a maximum expected length, given the size of the building), to help ensure power requirements are met.

In some embodiments, grouping may be further governed by rules and/or constraints provided by a user, which may help facilitate the subsequent routing of trunk lines and/or other cables providing power (and, optionally, data) from the trunk line to the individual windows. For example, a user may provide a rules to ensure each window in a group is within a threshold distance from the nearest window in the group and/or all windows have a common orientation (e.g., no single group has windows facing two directions). Additionally or alternatively, a user may provide rules to ensure certain windows are grouped together, such as windows that form a larger common panel of windows. According to some embodiments, such rules may be selectable by a user and provided via a user interface.

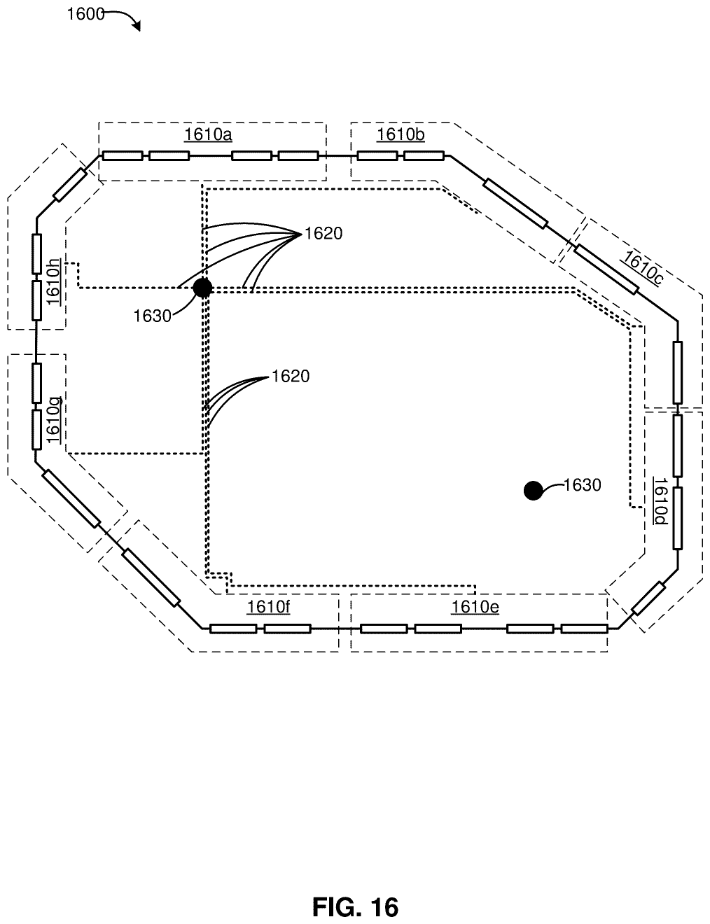

Returning to FIG. 13, the method 1300 may then comprise routing of the trunk lines to each window cluster, as indicated at block 1320. As noted, trunk lines can be routed from one or more control panels at one or more locations to power each cluster. Further, routing may be governed by layout rules and/or constraints provided by a user. Additional details regarding routing are provided hereafter with respect to FIG. 16

FIG. 16 is a diagram of a floorplan 1600, similar to diagrams in FIGS. 14 and 15, with clusters 1610a-1610h. Here, routing of trunk lines has been performed to show routes 1620 from a location 1630 of one or more control panels to each cluster. According to some embodiments, each cluster 1610a-1610h may be provided with an assigned trunk line ID with which trunk line for a given cluster can be identified.

As noted, the routing itself for each of the routes 1620 may be governed by layout rules and/or constraints provided by user (e.g., via a user interface). The user may, for example, identify areas of a building routing can and/or cannot be performed, preferred paths for routes, or the like. Depending on desired functionality, different routing approaches may be taken to help balance routing considerations such as complexity of installation, cable length optimization, or the like. Reduced complexity, for example, may involve a single route extending from the location 1630 of the control panel(s) to a path along and inside perimeter of the building that passes by all window clusters. This can enable all cables to share at least a portion of a single route, where each cable travels a different length of a shared common path before connecting with respective window cluster. Alternatively, a “hub-and-spoke” approach may connect each window cluster with a location 1630 with a direct path. This may increase complexity because routing paths would not be shared, however this would minimize cable lengths. Other approaches, such as the approach in FIG. 16, may provide a balanced approach that allows for shared paths and table length optimization. Again, these approaches may be governed by rules and/or constraints provided by the user.

As shown by the multiple locations 1630 in FIG. 16, some instances may have different options for locations for the one or more control panels. These location 1630 may be governed, for example, by a building structure, corresponding to locations at which power (and, optionally, data) to control panels can be routed from other levels of the building. In instances in which multiple locations (e.g., locations 1630) are available, a routing method may include routing trunk lines from each of the plurality of locations and selecting the location that provides better routes in view of one or more of the routing considerations previously mentioned (e.g., complexity, cable length, etc.). Some buildings may allow for one or more control panels at a plurality of locations, in which case routing may involve routing a trunk line from a corresponding window cluster to one of the plurality of locations (e.g., the closest location). According to some embodiments, the location(s) to use for routing may be user selectable.

The location at each window cluster 1610a-1610h to which trunk lines are routed may vary, depending on desired functionality. For simplicity, some embodiments may simply route a trunk line to a threshold distance to a center point of the respective window cluster. However, in some implementations, windows within a window cluster may be daisy chained such that a first cable extends from the trunk cable to a first window of the cluster, a second cable extends from the first window of the cluster to a second window of the cluster, and so on. Thus, in some embodiments, the routing process may route trunk lines from a location of the control panel to within a threshold distance of a first window of a respective window cluster.

Returning to FIG. 13, a voltage check may be performed, as indicated at block 1330. As previously noted, windows may be grouped into clusters based on a maximum power threshold that may be chosen to take into account a maximum prospective cable length. The voltage check at block 1330 can verify whether trunk lines can meet power requirements given the routes created at block 1320. In particular, because increased cable length comes with an increased drop in voltage, the voltage check may be performed to determine whether all trunk lines are capable of providing a threshold voltage for the respective window clusters. Because each window cluster may have different power requirements, a different threshold voltage may be used for each window cluster, based on the requirements of that cluster. According to some embodiments, a threshold voltage may be a certain amount above a maximum voltage requirement (e.g., in number of volts, percentage of the maximum, etc.) for the window cluster. This can help ensure sufficient voltage (e.g., in case one or more windows within the window cluster draws more power than expected). The maximum voltage requirement for a window cluster may be based on a maximum expected power draw for each window and corresponding controller.

If the voltage check fails, the method 1300 may iterate back to the routing of trunk lines at block 1320, as shown by arrow 1335, to reroute trunk lines in a manner that passes the voltage check. For a window cluster that failed the voltage check at block 1330, some embodiments may address this failure by splitting the window cluster in two so that two respective trunk cables can be used to power windows that were previously provided a single trunk cable. Additionally or alternatively, embodiments may impose new routing rules and/or constraints (e.g., reducing a maximum cable length) to help ensure a subsequent voltage check is passed. Additionally or alternatively, some embodiments may re-cluster windows to reduce the power requirements (e.g., reducing the number of windows) in each cluster.

At block 1340, the method 1300 comprises determining control panel requirements. Because control panels may be limited in the number of trunk lines they can support (e.g., 12, 24, 32, or 48 trunk lines, depending on the type of control panel), a number and type of control panels may be selected based on the routing performed at block 1320. That is, if routing results in a number of trunk lines that a number that a single control panel can support, and additional control panel can be used. Additionally or alternatively, if a single control panel is capable of supporting trunk lines for different levels of a building, the number of control panels may be correspondingly reduced. (Note, however, that additional routing may be needed to route trunk lines to a control panel on a different level or route trunk lines to/from power connections that connect trunk lines between levels.)

At block 1350, the method 1300 of FIG. 13 comprises exporting power values. As with the exporting of takeoff values (e.g., at block 950 of FIG. 9), the exporting of power values may vary, depending on desired functionality. According to some embodiments, power values may comprise a total number of trunk lines, control panels, controllers, connectors and/or associated hardware, or a combination thereof, for each level of a building and/or for an entire building (e.g., all levels of the building). In some embodiments a user may be allowed to select the types of data to be exported using, for example, a user interface in which available data types can be selected. According to some embodiments, the exporting power values may comprise the creation of interconnect drawings for routing trunk lines in accordance with the routing performed at block 1320. Such interconnect drawings may provide information relating to power distribution networks for electrochromic devices such as has been described in U.S. Pat. No. 10,253,558, issued Apr. 9, 2019, which is incorporated herein by reference in its entirety.

According to some embodiments, the exporting the power values at block 1350 may be incorporated into the generation of a BOM for a building project. For example, in some embodiments, the exporting of power values at block 1350 and the exporting of takeoff values at block 950 of FIG. 9 may be performed as part of the generation of a BOM for a project involving the manufacturing and/or insulation of optically-switchable windows for a building or other enclosure.

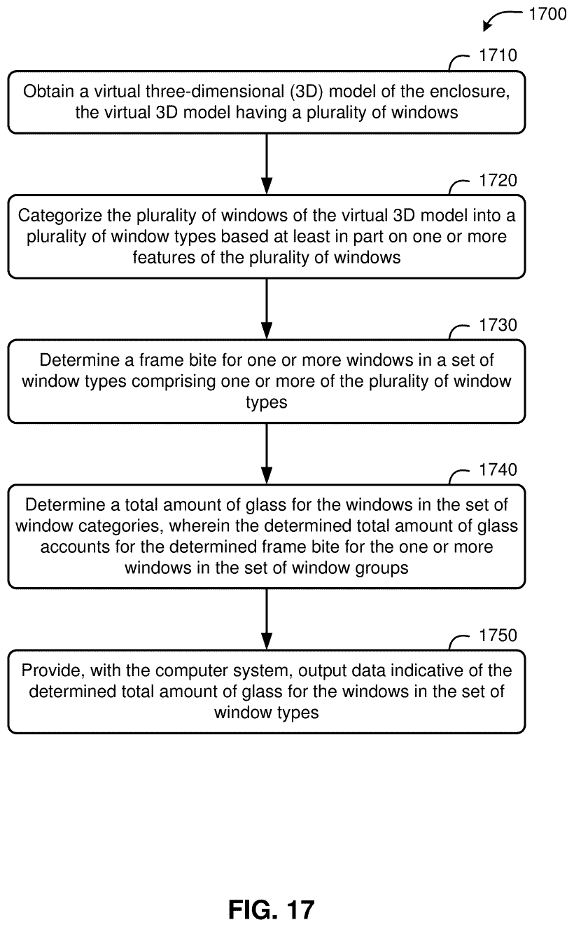

FIG. 17 is a flow diagram of a method 1700 for accurate glass measurement of an enclosure, according to an embodiment. Aspects of the method 1700 may correspond with previously-disclosed embodiments regarding model conditioning and/or takeoff, including embodiments described with respect to FIGS. 6-12. The functionality of one or more of the blocks illustrated in FIG. 17 may be performed, for example, by software and/or hardware components of a computer system, such as a personal computer (PC), tablet, notebook, computer server, or other computing system. Example computing system is described hereafter with regard to FIG. 19.

At block 1710, the functionality comprises obtaining a virtual three-dimensional (3D) model of the enclosure, the virtual 3D model having a plurality of windows. As noted herein, this may include one or more various aspects, depending on desired functionality. For example, as discussed with respect to block 510 of FIG. 5, obtaining a virtual model (e.g., a 3D model) of an enclosure may comprise obtaining a file or data stream comprising the virtual model. The enclosure may comprise a building. The virtual model may be obtained from local storage, or a device separate from a computer system executing the method 1700. According to some embodiments, the virtual 3D model comprises a BIM file. Additionally or alternatively, each window of the plurality of windows comprises a respective insulated glass unit (IGU). In some embodiments, at least a portion of the plurality of windows may comprise one or more optically-switchable windows.

At block 1720, the functionality comprises categorizing the plurality of windows of the virtual 3D model into a plurality of window types based at least in part on one or more features of the plurality of windows. According to some embodiments, for example, categorizing the plurality of windows of the virtual 3D model into a plurality of window types a comprise determining whether each window of the plurality of windows is an optically-switchable window. In such embodiments, determining whether each window of the plurality of windows is an optically-switchable window may be based at least in part on a size of the respective window, a shape of the respective window, or both. As also described herein, the one or more features of the plurality of windows may comprise a height, a width, a thickness, a shape, a location, an orientation, a material, a mounting type, or any combination thereof.

In some embodiments, for example, each window of the plurality of windows, the one or more features of a respective window may comprise a level of the enclosure in which the respective window is located. In such embodiments, the method 1700 may further comprise determining the level of the enclosure in which the respective window is located based at least in part on a position of the respective window relative to one or more planes (e.g., horizontal planes) representing level boundaries of the virtual 3D model. As noted, such planes may be included in the virtual model, or defined by a user (e.g., via a user interface).

As also noted, window type may also include orientation of a window. As such, according to some embodiments, for each window of the plurality of windows, the one or more features of a respective window may comprise an orientation of the respective window. In such embodiments, the method may further comprise determining the orientation of the respective window by determining a direction of a vector perpendicular to a plane formed by the respective window (e.g., in a glass panel of the window). As noted, a length of the vector may be selected to help ensure the end of the vector is clearly inside or outside the enclosure.

As noted herein (e.g., with respect to FIG. 10), some embodiments may include a visualization of window types. As such, some embodiments of the method 1700 may further comprise providing, with a graphical user interface (GUI), a visualization of the enclosure that identifies the plurality of windows based at least in part on window type. According to some embodiments, way in which the visualization identifies the plurality of windows may be user customizable. The user may, for example, select a type of shading, coloration, pattern, or combination thereof, with which each window type can be identified in the visualization. Additionally or alternatively, some embodiments may enable a user to change a window type of a selected window via the GUI.

Some embodiments may allow for a user to manually review and categorize windows. For example, some embodiments of the method 1700 may further comprise identifying one or more windows of the virtual 3D model that were unable to be categorized into a window type of the plurality of window types. In such embodiments, windows may be flagged for review by a user, who may provide input regarding a window type (e.g., a new window type or an existing window type) to which flagged windows may belong. As such, some embodiments may comprise assigning a window type of the plurality of window types to at least one of the one or more windows of the virtual 3D model that were unable to be categorized into a window type, wherein assigning the window type is based at least in part on a user input.

At block 1730, the functionality comprises determining a frame bite for one or more windows in a set of window types comprising one or more of the plurality of window types. Here, a set of window types comprise, for example, a subset of the plurality of window types having a frame bite. As noted in the previously-discussed embodiments, determining a frame bite may include a variety of operations, including those discussed with respect to FIGS. 11A and 11B, for example. For example, determining the frame bite for the one or more windows may comprise categorizing each of the one or more windows by a mounting type and determining the frame bite for each mounting type. In such embodiments, determining the frame bite for each mounting type may comprise determining a spatial offset between a window and a mullion for the respective mounting type. This determination can be done automatically (e.g., via a script), for example, by analyzing window features of the virtual model of the enclosure. That said, some embodiments may utilize user input. For example, in some embodiments determining the frame bite for each mounting type may comprise providing a description of each mounting type with a GUI, and receiving, for each mounting type, user input indicative of a frame bite for the respective mounting type. Such embodiments may further comprise providing a GUI that allows for selection of a mounting type; and provides a visualization of an instance of a selected mounting type within the virtual 3D model.

At block 1740, the functionality comprises determining a total amount of glass for the windows in the set of window categories, wherein the determined total amount of glass accounts for the determined frame bite for the one or more windows in the set of window groups. As noted herein with regard to the takeoff process, an amount of glass (e.g., is measured in surface area and/or volume) for relevant windows of an enclosure may be adjusted (e.g., from initial window measurements based on window dimensions) to include glass of a frame bite. This adjustment may be made for all windows having a frame bite, and windows of the same type having the same frame bite may be adjusted by the same amount.

At block 1750, the functionality comprises providing, with the computer system, output data indicative of the determined total amount of glass for the windows in the set of window types. As indicated in the previously-discussed embodiments, the output data may further include, for each window type of the set of window types, a number of windows of the respective window type. According to some embodiments, providing the output data comprises displaying the output data via a GUI, providing the output data to a computer application, or both. Further, values may be provided via a file (e.g., comma separated value (CSV) file, Microsoft® Excel® file, HTML file, XML file, etc.), stream, or other format, or combination thereof. According to some embodiments, the types of values provided by the computer system and/or the way in which values are provided by the computer system may be user configurable.

As also discussed herein, embodiments may involve identifying windows within a virtual model of an enclosure. This may involve, for example, identifying glass elements in the virtual 3D model using material properties of elements in the virtual 3D model, element categories in the virtual 3D model, or a combination thereof. Additionally or alternatively, embodiments may comprise identifying non-glass elements in the virtual 3D model using material properties of elements in the virtual 3D model, element categories in the virtual 3D model, or a combination thereof.

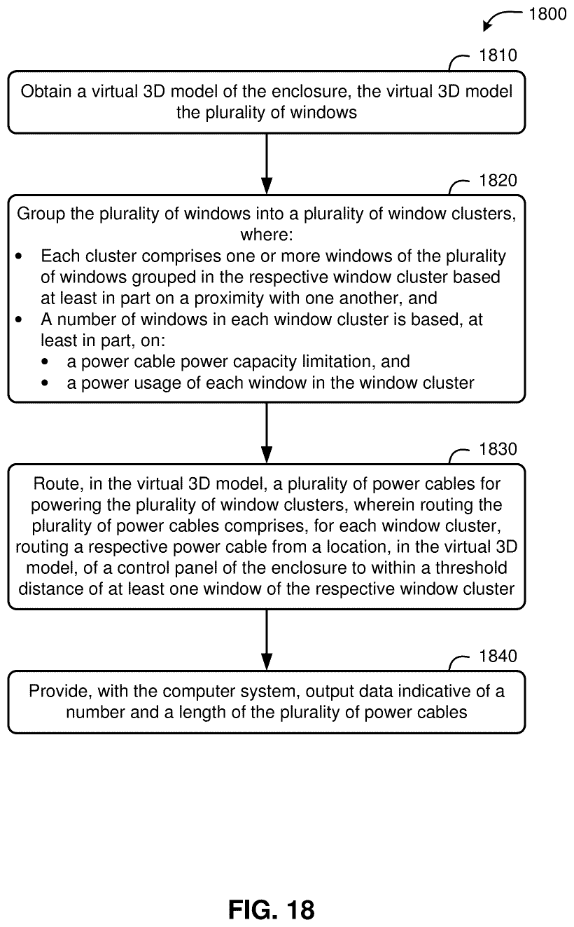

FIG. 18 is a flow diagram of a method 1800 for performing cable layout for powering (and, optionally, providing data to) a plurality of windows of an enclosure, according to an embodiment. Aspects of the method 1800 may correspond with previously-disclosed embodiments regarding cable routing, including embodiments described with respect to FIGS. 13-16. Similar to the method 1700 of FIG. 17, the functionality of one or more of the blocks illustrated in FIG. 18 may be performed, for example, by software and/or hardware components of a computer system, such as a PC, tablet, notebook, computer server, or other computing system. Again, an example computing system is described hereafter with regard to FIG. 19.

At block 1810, the functionality comprises obtaining a virtual three-dimensional (3D) model of the enclosure, the virtual 3D model the plurality of windows. Here, the plurality of windows may comprise windows for which power may be needed to perform certain functions (e.g., window tinting, hue/color adjustment, etc.). As noted herein, this may include one or more various aspects, depending on desired functionality. For example, as discussed with respect to block 510 of FIG. 5, obtaining a virtual model (e.g., a 3D model) of an enclosure may comprise obtaining a file or data stream comprising the virtual model. The enclosure may comprise a building. The virtual model may be obtained from local storage, or a device separate from a computer system executing the method 1800. According to some embodiments, the virtual 3D model comprises a BIM file. Additionally or alternatively, each window of the plurality of windows comprises a respective insulated glass unit (IGU). In some embodiments, at least a portion of the plurality of windows may comprise one or more optically-switchable windows.

At block 1820, the functionality comprises grouping the plurality of windows into a plurality of window clusters, wherein each cluster comprises one or more windows of the plurality of windows grouped in the respective window cluster based at least in part on a proximity with one another, and a number of windows in each window cluster is based, at least in part, on: a cable (e.g., power cable providing power, and optionally data) power capacity limitation, and a power usage of each window in the window cluster. As described herein, windows may be assigned numbers based on location, where adjacent numbers represent adjacent windows. As discussed with regard to FIGS. 14 and 15, the number of adjacent windows in a group may be limited based on the power capacity of a cable (e.g., trunk line), which may be based on a maximum expected length of the cable. According to some embodiments, the cable power capacity limitation is based, at least in part, on user input, a standard cable length, or both.

The number of windows in the group may further be based on the power requirements for each window (which may be determined by window size, circuitry, other aspects of the window, or combination thereof). According to some embodiments, the method 1800 may further comprise providing, with a GUI, a visualization of the enclosure that identifies each window cluster of the plurality of window clusters. As detailed herein, different window clusters may be identified in the visualization, for example, by using different shading, colors, patterns, or combination thereof. A GUI may further be used to enable a user to assign one or more windows within a first window cluster of the plurality of window clusters to a second window cluster of the plurality of window clusters.

At block 1830, the functionality comprises routing, in the virtual 3D model, a plurality of cables for powering the plurality of window clusters, wherein routing the plurality of cables comprises, for each window cluster, routing a respective cable from a location, in the virtual 3D model, of a control panel of the enclosure to within a threshold distance of at least one window of the respective window cluster. As described with regard to FIG. 16, the routing of cables (e.g., trunk lines) may be an automated process. This process may be governed by rules and/or constraints provided by a user regarding where routes may and/or may not be placed.

As indicated in the method 1300 of FIG. 13, routing may involve an iterative process in which the routing of cables is followed by a voltage check to verify cables can supply sufficient power. After the voltage check indicates failure in the routing, the process can start over with new routes. With this in mind, embodiments of the method 1800 may further comprise performing a voltage check to determine whether each cable of the plurality of cables is capable of providing at least a threshold voltage to the respective window cluster to which the respective cable is routed. Such embodiments may further comprise, responsive to a determination that a particular cable of the plurality of cables is incapable of providing at least the threshold voltage to a window cluster to which the particular cable is routed, providing, via a graphical user interface of the computer system, an indication to a user that the particular cable has not passed the voltage check. Additionally or alternatively, embodiments may include, responsive to a determination that a particular cable of the plurality of cables is incapable of providing at least the threshold voltage to a window cluster to which the particular cable is routed, providing an alternative route for the particular cable, revising the window cluster to which the particular cable is routed, or both. In such embodiments, revising the window cluster a comprise changing a number of windows in the window cluster, replacing one or more of the windows in the cluster with one or more windows of a different window type, or both. Replacing a window of one window type another window of different type may help me power requirements where different window types have different power requirements. Some embodiments may further comprise, responsive to a determination that a particular cable of the plurality of cables is incapable of providing at least the threshold voltage to a window cluster to which the particular cable is routed, moving the location of the control panel. As noted herein, moving the location of the control panel may comprise selecting a new control panel location from a plurality of available control panel locations. In some embodiments, performing the voltage check comprises determining a voltage drop along each cable. This determination may be based, for example, on a known relationship between cable length and voltage drop for the type of cables used.

At block 1840, the functionality comprises providing, with the computer system, output data indicative of a number and a length of the plurality of cables. According to some embodiments, the length of the plurality of cables may comprise a combined length of the plurality of cables, a length of each cable of the plurality of cables, or both. Moreover, as noted elsewhere herein, the output data may comprise displaying the output data via a GUI, providing the output data to a computer application, or both.

As noted in the embodiments described herein, there may be some flexibility in the use of control panels at different locations, which can enable different functionality. There may be, for example, a plurality of locations (may be predefined) at which control panels may be located. As such, some embodiments may involve determining a location of the control panel. According to some embodiments, this determination may be based, at least in part, on user input. For example, a user may select a desired location for one or more control panels from a list and/or visualization of available locations. Some embodiments may comprise determining a number of control panels for one or more levels of the enclosure based at least in part on a number of the plurality of window clusters. For example, determining the number of control panels for one or more levels of the enclosure may comprise determining the control panel is incapable of providing sufficient power to the plurality of window clusters and adding a second control panel. In such embodiments, adding the second control panel may comprise routing, in the virtual model, a subset of the plurality of cables to the second control panel, the subset of the plurality of cables for powering a subset of the plurality of window clusters. As noted herein, locations may be the same or different for different control panels. Further, different control panel types may have different capacities. In particular, some control panel types may be capable of supporting more cables, for example, then other control panel types. As such, some embodiments may further comprise determining a control panel type for the control panel based at least in part on a number of the plurality of window clusters.

FIG. 19 shows a schematic example of a computer system 1900 that is programmed or otherwise configured to one or more operations of any of the methods provided herein, including the methods described with respect to FIGS. 17 and 18 and, more generally, functions described herein with regard to CAD design and BOM generation. The computer may be coupled to one or more mechanisms disclosed herein, and/or any parts thereof. The computer system can be used to execute software programs that provide a graphical user interface (GUI) as described herein. The GUI may be used to provide information to and/or receive input from a user.

The computer system can include a processing unit (e.g., 1906) (also “processor,” “computer” and “computer processor” used herein). The computer system may include memory or memory location (e.g., 1902) (e.g., random-access memory, read-only memory, flash memory), electronic storage unit (e.g., 1904) (e.g., hard disk), communication interface (e.g., 1903) (e.g., network adapter) for communicating with one or more other systems, and peripheral devices (e.g., 1905), such as cache, other memory, data storage and/or electronic display adapters. In the example shown in FIG. 19, the memory 1902, storage unit 1904, interface 1903, and peripheral devices 1905 are in communication with the processing unit 1906 through a communication bus (solid lines), such as a motherboard. The storage unit can be a data storage unit (or data repository) for storing data. The computer system can be operatively coupled to a computer network (“network”) (e.g., network 1901) with the aid of the communication interface. The network can be the Internet, an internet and/or extranet, or an intranet and/or extranet that is in communication with the Internet. In some cases, the network is a telecommunication and/or data network. The network can include one or more computer servers, which can enable distributed computing, such as cloud computing. The network, in some cases with the aid of the computer system, can implement a peer-to-peer network, which may enable devices coupled to the computer system to behave as a client or a server.

The processing unit can execute a sequence of machine-readable instructions, which can be embodied in a program or software. The instructions may be stored in a memory location, such as the memory 1902. The instructions can be directed to the processing unit, which can subsequently program or otherwise configure the processing unit to implement methods of the present disclosure. Examples of operations performed by the processing unit can include fetch, decode, execute, and write back. The processing unit may interpret and/or execute instructions. The processor may include a microprocessor, a data processor, a central processing unit (CPU), a graphical processing unit (GPU), a system-on-chip (SOC), a co-processor, a network processor, an application specific integrated circuit (ASIC), an application specific instruction-set processor (ASIPs), a controller, a programmable logic device (PLD), a chipset, a field programmable gate array (FPGA), or any combination thereof. The processing unit can be part of a circuit, such as an integrated circuit. One or more other components of the system 1900 can be included in the circuit.

The storage unit can store files, such as drivers, libraries and saved programs. The storage unit can store user data (e.g., user preferences and user programs). In some cases, the computer system can include one or more additional data storage units that are external to the computer system, such as located on a remote server that is in communication with the computer system through an intranet or the Internet.

The computer system can communicate with one or more remote computer systems through a network. For instance, the computer system can communicate with a remote computer system of a user (e.g., operator). Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. A user (e.g., client) can access the computer system via the network.

Methods as described herein can be implemented by way of machine (e.g., computer processor) executable code stored on an electronic storage location of the computer system, such as, for example, on the memory 1902 or electronic storage unit 1904. The machine executable or machine-readable code can be provided in the form of software. During use, the processing unit 1906 can execute the code. In some cases, the code can be retrieved from the storage unit and stored on the memory for ready access by the processor. In some situations, the electronic storage unit can be precluded, and machine-executable instructions are stored on memory.

The code can be pre-compiled and configured for use with a machine have a processer adapted to execute the code or can be compiled during runtime. The code can be supplied in a programming language that can be selected to enable the code to execute in a pre-compiled or as-compiled fashion.

In some embodiments, the processor comprises a code. The code can be program instructions. The program instructions may cause the at least one processor (e.g., computer) to direct a feed forward and/or feedback control loop. In some embodiments, the program instructions cause the at least one processor to direct a closed loop and/or open loop control scheme. The control may be based at least in part on one or more sensor readings (e.g., sensor data). One controller may direct a plurality of operations. At least two operations may be directed by different controllers. In some embodiments, a different controller may direct at least two of operations (a), (b) and (c). In some embodiments, different controllers may direct at least two of operations (a), (b) and (c). In some embodiments, a non-transitory computer-readable medium cause each a different computer to direct at least two of operations (a), (b) and (c). In some embodiments, different non-transitory computer-readable mediums cause each a different computer to direct at least two of operations (a), (b) and (c). The controller and/or computer readable media may direct any of the apparatuses or components thereof disclosed herein. The controller and/or computer readable media may direct any operations of the methods disclosed herein.

In some embodiment a software application may comprise a facility visualizer. The software application may offer a user the ability to observe, manipulate (e.g., revise or adjust), and/or create various features relating to the facility (e.g., a building or other disclosure as described herein). The feature may relate to the architectural structure of the facility (e.g., fixtures), to assets (e.g., non-fixtures and/or devices) of the facilities, to a network of the facility, and/or to a control system of the facility. For example, the facility visualizer (e.g., building visualizer) may facilitate utilization, alteration, and/or creation of a BOM and/or takeoff process, and may provide visualizations as described herein via a GUI of the facility visualizer software application (e.g., app). The app may reside on a cloud or locally (e.g., in the facility or outside of the facility).

In some embodiments, the software application may present a virtual visualization of the facility in its surroundings in the real-world. For example, the software application may present an image (on a GUI) of the facility in a municipal surrounding (e.g., urban surrounding), and/or in a topographical surrounding. For example, the software application may present an image (on a GUI) of the facility in conjunction with any civil and/or structural engineering features (e.g., roads, bridges, and/or water fountains). These features may be consider during rendering of the facility, e.g., considering their influence on the facility's exterior and/or interior (e.g., internal environment).

In some embodiments, the app utilizes a software module including APIs and/or services that help access and/or use the facility's design and engineering data (e.g., via the cloud). In some embodiments, the app may utilize a software module configured to allow access to design and engineering data in the cloud (e.g., Autodesk Forge platform). The app may facilitate extraction of an underlying code of a third party cloud design and/or engineering software (e.g., Autodesk Forge). For example, the app may facilitate extraction of an open standard file format and/or data interchange format (e.g., that uses human-readable text to store and transmit data objects consisting of attribute-value pairs and arrays (and/or other serializable values)). The app may facilitate extraction of a language-independent data format. For example, the app may facilitate extraction of JavaScript, or JavaScript related formats. For example, the app may facilitate extraction of JavaScript Object Notation (JSON) such as HBJSON. The app may facilitate extraction of the file format from such cloud application (e.g., from the Forge Model). The extracted file may be utilized for a control module (e.g., Intelligence) configured to control the facility (e.g., control devices of the facility). For example, the extracted file (e.g., HBJSON file) may be utilized to pollinate the control system (e.g., by pollinating the Intelligence module, e.g., in the cloud), and/or into the (e.g., local) database of the facility. The database of the facility can be in the cloud or not in the cloud. The database may be in the facility or external to the facility.

While preferred embodiments of the present invention have been shown, and described herein, it will be obvious to those skilled in the art that such embodiments are provided by way of example only. It is not intended that the invention be limited by the specific examples provided within the specification. While the invention has been described with reference to the afore-mentioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations, or relative proportions set forth herein which depend upon a variety of conditions and variables. It should be understood that various alternatives to the embodiments of the invention described herein might be employed in practicing the invention. It is therefore contemplated that the invention shall also cover any such alternatives, modifications, variations, or equivalents. It is intended that the following claims define the scope of the invention and that methods and structures within the scope of these claims and their equivalents be covered thereby.

In view of this description embodiments may include different combinations of features. Implementation examples are described in the following numbered clauses:
Clause 1: A method performed by a computer system for accurate glass measurement of an enclosure, the method comprising obtaining a virtual three-dimensional (3D) model of the enclosure, the virtual 3D model having a plurality of windows; categorizing the plurality of windows of the virtual 3D model into a plurality of window types based at least in part on one or more features of the plurality of windows; determining a frame bite for one or more windows in a set of window types comprising one or more of the plurality of window types; determining a total amount of glass for the windows in the set of window categories, wherein the determined total amount of glass accounts for the determined frame bite for the one or more windows in the set of window groups; and providing, with the computer system, output data indicative of the determined total amount of glass for the windows in the set of window types.
Clause 2: The method of clause 1, wherein categorizing the plurality of windows of the virtual 3D model into a plurality of window types comprises determining whether each window of the plurality of windows is an optically-switchable window.
Clause 3: The method of clause 2, wherein determining whether each window of the plurality of windows is an optically-switchable window is based at least in part on a size of the respective window, a shape of the respective window, or both.
Clause 4: The method of any one of clauses 1-3, further comprising identifying glass elements in the virtual 3D model using material properties of elements in the virtual 3D model.
Clause 5: The method of clause 4, wherein identifying the glass elements comprises identifying glass elements using element categories in the virtual 3D model.
Clause 6: The method of any one of clauses 1-5, further comprising identifying non-glass elements in the virtual 3D model using material properties of elements in the virtual 3D model.
Clause 7: The method of clause 6, wherein identifying the non-glass elements comprises identifying glass elements using element categories in the virtual 3D model.
Clause 8: The method of any one of clauses 1-7, further comprising providing, with a graphical user interface (GUI), a visualization of the enclosure that identifies the plurality of windows based at least in part on window type.
Clause 9: The method of clause 8, further comprising enabling a user to change a window type of a selected window via the GUI.
Clause 10: The method of any one of clauses 1-9, further comprising identifying one or more windows of the virtual 3D model that were unable to be categorized into a window type of the plurality of window types.
Clause 11: The method of clause 10, further comprising assigning a window type of the plurality of window types to at least one of the one or more windows of the virtual 3D model that were unable to be categorized into a window type, wherein assigning the window type is based at least in part on a user input.
Clause 12: The method of any one of clauses 1-11, wherein, for each window of the plurality of windows, the one or more features of a respective window comprises a level of the enclosure in which the respective window is located, and wherein the method further comprises determining the level of the enclosure in which the respective window is located based at least in part on a position of the respective window relative to one or more planes representing level boundaries of the virtual 3D model.
Clause 13: The method of any one of clauses 1-12, wherein, for each window of the plurality of windows, the one or more features of a respective window comprises an orientation of the respective window.
Clause 14: The method of clause 13, further comprising determining the orientation of the respective window by determining a direction of a vector perpendicular to a plane formed by the respective window.
Clause 15: The method of any one of clauses 1-14, wherein determining the frame bite for the one or more windows comprises: categorizing each of the one or more windows by a mounting type; and determining the frame bite for each mounting type.
Clause 16: The method of clause 15, wherein determining the frame bite for each mounting type comprises determining a spatial offset between a window and a mullion for the respective mounting type.
Clause 17: The method of either of clauses 15 or 16, wherein determining the frame bite for each mounting type comprises: providing a description of each mounting type with a GUI; and receiving, for each mounting type, user input indicative of a frame bite for the respective mounting type.
Clause 18: The method of clause 17, further comprising providing a GUI that: allows for selection of a mounting type; and provides a visualization of an instance of a selected mounting type within the virtual 3D model.
Clause 19: The method of any one of clauses 1-18, wherein the output data further includes, for each window type of the set of window types, a number of windows of the respective window type.
Clause 20: The method of any one of clauses 1-19, wherein the virtual 3D model comprises a building information modeling (BIM) file.
Clause 21: The method of any one of clauses 1-20, wherein each window of the plurality of windows comprises a respective insulated glass unit (IGU).
Clause 22: The method of any one of clauses 1-21, wherein at least a portion of the plurality of windows comprises one or more optically-switchable windows.
Clause 23: The method of any one of clauses 1-22, wherein the enclosure comprises a building.
Clause 24: The method of any one of clauses 1-23, wherein the one or more features of the plurality of windows comprise a height, a width, a thickness, a shape, a location, an orientation, a material, a mounting type, or any combination thereof.
Clause 25: The method of any one of clauses 1-24, wherein providing the output data comprises displaying the output data via a GUI, providing the output data to a computer application, or both.
Clause 26: A method performed by a computer system for performing power cable layout for powering a plurality of windows of an enclosure, the method comprising: obtaining a virtual three-dimensional (3D) model of the enclosure, the virtual 3D model the plurality of windows; grouping the plurality of windows into a plurality of window clusters, wherein: each cluster comprises one or more windows of the plurality of windows grouped in the respective window cluster based at least in part on a proximity with one another, and a number of windows in each window cluster is based, at least in part, on: a power cable power capacity limitation, and a power usage of each window in the window cluster; routing, in the virtual 3D model, a plurality of power cables for powering the plurality of window clusters, wherein routing the plurality of power cables comprises, for each window cluster, routing a respective power cable from a location, in the virtual 3D model, of a control panel of the enclosure to within a threshold distance of at least one window of the respective window cluster; and providing, with the computer system, output data indicative of a number and a length of the plurality of power cables.
Clause 27: The method of clause 26, further comprising performing a voltage check to determine whether each power cable of the plurality of power cables is capable of providing at least a threshold voltage to the respective window cluster to which the respective power cable is routed.
Clause 28: The method of clause 27, further comprising, responsive to a determination that a particular power cable of the plurality of power cables is incapable of providing at least the threshold voltage to a window cluster to which the particular power cable is routed, providing, via a graphical user interface of the computer system, an indication to a user that the particular power cable has not passed the voltage check.
Clause 29: The method of either of clauses 27 or 28, further comprising, responsive to a determination that a particular power cable of the plurality of power cables is incapable of providing at least the threshold voltage to a window cluster to which the particular power cable is routed, providing an alternative route for the particular power cable, revising the window cluster to which the particular power cable is routed, or both.
Clause 30: The method of clause 29, wherein revising the window cluster comprises changing a number of windows in the window cluster, replacing one or more of the windows in the cluster with one or more windows of a different window type, or both.
Clause 31: The method of any one of clauses 27-30, further comprising, responsive to a determination that a particular power cable of the plurality of power cables is incapable of providing at least the threshold voltage to a window cluster to which the particular power cable is routed, moving the location of the control panel.
Clause 32: The method of any one of clauses 27-31, wherein performing the voltage check comprises determining a voltage drop along each power cable.
Clause 33: The method of any one of clauses 26-32, wherein the length of the plurality of power cables comprises a combined length of the plurality of power cables, a length of each power cable of the plurality of power cables, or both.
Clause 34: The method of any one of clauses 26-33, wherein the power cable power capacity limitation is based, at least in part, on user input.
Clause 35: The method of any one of clauses 26-34, wherein the power cable power capacity limitation is based, at least in part, on a standard power cable length.
Clause 36: The method of any one of clauses 26-35, further comprising determining the location of the control panel based, at least in part, on user input.
Clause 37: The method of any one of clauses 26-36, further comprising determining a number of control panels for one or more levels of the enclosure based at least in part on a number of the plurality of window clusters.
Clause 38: The method of clause 37, wherein determining the number of control panels for one or more levels of the enclosure comprises determining the control panel is incapable of providing sufficient power to the plurality of window clusters and adding a second control panel.
Clause 39: The method of clause 38, wherein adding the second control panel comprises routing, in the virtual model, a subset of the plurality of power cables to the second control panel, the subset of the plurality of power cables for powering a subset of the plurality of window clusters.
Clause 40: The method of any one of clauses 26-39, further comprising determining a control panel type for the control panel based at least in part on a number of the plurality of window clusters.
Clause 41: The method of any one of clauses 26-40, further comprising providing, with a GUI, a visualization of the enclosure that identifies each window cluster of the plurality of window clusters.
Clause 42: The method of clause 41, further comprising enabling a user to use the GUI to assign one or more windows within a first window cluster of the plurality of window clusters to a second window cluster of the plurality of window clusters.
Clause 43: The method of any one of clauses 26-42, wherein the virtual 3D model comprises a building information modeling (BIM) file.
Clause 44: The method of any one of clauses 26-43, wherein each window of the plurality of windows comprises a respective insulated glass unit (IGU).
Clause 45: The method of any one of clauses 26-44, wherein at least a portion of the plurality of windows comprises one or more optically-switchable windows.
Clause 46: The method of any one of clauses 26-45, wherein the enclosure comprises a building.
Clause 47: The method of any one of clauses 26-46, wherein providing the output data comprises displaying the output data via a GUI, providing the output data to a computer application, or both.

A computer system comprising at least one processor coupled with at least one memory, the at least one processor configured to perform the method of any one of clauses 1-47.

A system of one or more communicatively coupled computing devices configured to perform the method of any one of clauses 1-47.

An apparatus having means for performing the method of any one of clauses 1-47.

A non-transitory computer-readable medium storing instructions, the instructions comprising code for performing the method of any one of clauses 1-47.

What is claimed is:

1. A method performed by a computer system for accurate glass measurement of an enclosure, the method comprising:
obtaining a virtual three-dimensional (3D) model of the enclosure, the virtual 3D model having a plurality of windows;
categorizing the plurality of windows of the virtual 3D model into a plurality of window types based at least in part on one or more features of the plurality of windows;
determining a frame bite for one or more windows in a set of window types comprising one or more of the plurality of window types;
determining a total amount of glass for the windows in the set of window categories, wherein the determined total amount of glass accounts for the determined frame bite for the one or more windows in the set of window groups; and
providing, with the computer system, output data indicative of the determined total amount of glass for the windows in the set of window types.

2. The method of claim 1, wherein categorizing the plurality of windows of the virtual 3D model into a plurality of window types comprises determining whether each window of the plurality of windows is an optically-switchable window.

3. The method of claim 2, wherein determining whether each window of the plurality of windows is an optically-switchable window is based at least in part on a size of the respective window, a shape of the respective window, or both.

4. The method of claim 1, further comprising identifying glass elements in the virtual 3D model using material properties of elements in the virtual 3D model.

5. The method of claim 4, wherein identifying the glass elements comprises identifying glass elements using element categories in the virtual 3D model.

6. The method of claim 1, further comprising identifying non-glass elements in the virtual 3D model using material properties of elements in the virtual 3D model.

7. The method of claim 6, wherein identifying the non-glass elements comprises identifying glass elements using element categories in the virtual 3D model.

8. The method of claim 1, further comprising providing, with a graphical user interface (GUI), a visualization of the enclosure that identifies the plurality of windows based at least in part on window type.

9. The method of claim 8, further comprising enabling a user to change a window type of a selected window via the GUI.

10. The method of claim 1, further comprising identifying one or more windows of the virtual 3D model that were unable to be categorized into a window type of the plurality of window types.

11. The method of claim 10, further comprising assigning a window type of the plurality of window types to at least one of the one or more windows of the virtual 3D model that were unable to be categorized into a window type, wherein assigning the window type is based at least in part on a user input.

12. The method of claim 1, wherein, for each window of the plurality of windows, the one or more features of a respective window comprises a level of the enclosure in which the respective window is located, and wherein the method further comprises determining the level of the enclosure in which the respective window is located based at least in part on a position of the respective window relative to one or more planes representing level boundaries of the virtual 3D model.

13. The method of claim 1, wherein, for each window of the plurality of windows, the one or more features of a respective window comprises an orientation of the respective window.

14. The method of claim 13, further comprising determining the orientation of the respective window by determining a direction of a vector perpendicular to a plane formed by the respective window.

15. The method of claim 1, wherein determining the frame bite for the one or more windows comprises:
categorizing each of the one or more windows by a mounting type; and
determining the frame bite for each mounting type.

16. The method of claim 15, wherein determining the frame bite for each mounting type comprises determining a spatial offset between a window and a mullion for the respective mounting type.

17. The method claim 15, wherein determining the frame bite for each mounting type comprises:
providing a description of each mounting type with a GUI; and
receiving, for each mounting type, user input indicative of a frame bite for the respective mounting type.

18. The method of claim 17, further comprising providing a GUI that:
allows for selection of a mounting type; and
provides a visualization of an instance of a selected mounting type within the virtual 3D model.

19. A computer system comprising:
at least one memory; and
at least one processor communicatively coupled with the at least one memory and configured to:
obtain a virtual three-dimensional (3D) model of an enclosure, the virtual 3D model having a plurality of windows;
categorize the plurality of windows of the virtual 3D model into a plurality of window types based at least in part on one or more features of the plurality of windows;
determine a frame bite for one or more windows in a set of window types comprising one or more of the plurality of window types;
determine a total amount of glass for the windows in the set of window categories, wherein the determined total amount of glass accounts for the determined frame bite for the one or more windows in the set of window groups; and
provide, with the computer system, output data indicative of the determined total amount of glass for the windows in the set of window types.

20. A non-transitory computer-readable medium storing instructions for accurate glass measurement of an enclosure, the instructions comprising code for:
obtaining a virtual three-dimensional (3D) model of the enclosure, the virtual 3D model having a plurality of windows;
categorizing the plurality of windows of the virtual 3D model into a plurality of window types based at least in part on one or more features of the plurality of windows;
determining a frame bite for one or more windows in a set of window types comprising one or more of the plurality of window types;
determining a total amount of glass for the windows in the set of window categories, wherein the determined total amount of glass accounts for the determined frame bite for the one or more windows in the set of window groups; and
providing, with the computer system, output data indicative of the determined total amount of glass for the windows in the set of window types.
